(19) United States
(12) Patent Application Publication
(10) Pub. No.: US 2017/0026278 A1
(43) Pub. Date: Jan. 26, 2017

(54) COMMUNICATION APPARATUS, CONTROL APPARATUS, AND COMMUNICATION SYSTEM

(71) Applicant: HITACHI METALS, LTD., Tokyo (JP)

(72) Inventors: Satoshi TSUTSUMI, Tokyo (JP); Koji WAKAYAMA, Tokyo (JP); Hitoshi KUWATA, Tokyo (JP)

(73) Assignee: HITACHI METALS, LTD., Tokyo (JP)

(21) Appl. No.: 15/161,347

(22) Filed: May 23, 2016

(30) Foreign Application Priority Data
Jul. 23, 2015 (JP) 2015-146010

(51) Int. Cl. H04L 12/703; H04L 12/24; H04L 12/26

(52) U.S. Cl. CPC H04L 45/28; H04L 43/0829; H04L 41/12

(57) ABSTRACT

A communication apparatus for transmitting and receiving data is configured to: store assertion information in which a failure detection condition is registered, the failure detection condition including information for identifying data that is not to be received during normal operation; refer to the assertion information when data has been received from another communication apparatus; judge whether or not the received data satisfies the failure detection condition registered in the assertion information; and detect a failure when it is judged that the received data satisfies the failure detection condition registered in the assertion information.

### CLAIM OF PRIORITY

The present application claims priority from Japanese patent application JP 2015-146010 filed on Jul. 23, 2015, the content of which is hereby incorporated by reference into this application.

### BACKGROUND OF THE INVENTION

This invention relates to a communication apparatus configured to detect a failure.

As technologies for identifying a network failure, there are given JP 2013-46090 A and ITU-T, “G.8032/Y.1344 Ethernet ring protection switching,” February 2012. In JP 2013-46090 A, it is disclosed that “when a failure is detected by ERP, based on a failure detection result and topology information registered in the topology information table, the failure type (apparatus failure or link failure) is judged. In the case of an apparatus failure, the apparatus in which the failure occurred is identified, and a higher layer (layer 3) is notified of the identification result” (refer to paragraph [0030]).

In ITU-T, “G.8032/Y.1344 Ethernet ring protection switching,” February 2012, it is disclosed that “As an example, the ring links of each Ethernet ring node may be monitored by individually exchanging continuity check messages (CCM)” (refer to page 9).

In order to improve network reliability, it is necessary to detect network failures. In JP 2013-46090 A, a method of detecting a failure by using Ethernet (trademark) Ring Protection (ERP) is disclosed. Further, in ITU-T, “G.8032/Y.1344 Ethernet ring protection switching,” February 2012 that defines ERP, a method of detecting a link failure by periodically transmitting and receiving a Continuity Check Message (CCM), which is a message for checking continuity, is disclosed.

However, in the technologies disclosed in JP 2013-46090 A and ITU-T, “G.8032/Y.1344 Ethernet ring protection switching,” February 2012, failures that cannot be detected by transmitting and receiving a test packet such as a CCM are not considered. For example, when a hardware fault caused by cosmic radiation and the like has occurred, which is becoming more frequent with the miniaturization of semiconductors, even when there is no problem in the transmission and reception of a test packet, such as a CCM, a failure may occur in the transmission and reception of user packets other than the test packet.

### SUMMARY OF THE INVENTION

It is an object of this invention to provide a communication apparatus capable of detecting a failure that cannot be detected by a test packet.

For achieving the object, this invention is a communication apparatus for transmitting and receiving data, the communication apparatus being configured to: store assertion information in which a failure detection condition is registered, the failure detection condition including information for identifying data that is not to be received during normal operation; refer to the assertion information when data has been received from another communication apparatus; judge whether or not the received data satisfies the failure detection condition registered in the assertion information; and detect a failure when it is judged that the received data satisfies the failure detection condition registered in the assertion information.

According to this invention, the communication apparatus capable of detecting a failure that cannot be detected by a test packet can be provided.

The problems to be solved by this invention, the configurations, and the advantageous effects other than those described above according to this invention are made clear based on the following description of the embodiments.

### BRIEF DESCRIPTIONS OF DRAWINGS

The present invention can be appreciated by the description which follows in conjunction with the following figures, wherein:

FIG. 1 is a block diagram for illustrating a configuration of a communication system according to a first embodiment;

FIG. 2 is an explanatory diagram of a configuration example of the network 310 according to the first embodiment;

FIG. 3 is an explanatory diagram of the flow table of the communication apparatus (SW1) according to the first embodiment;

FIG. 4 is an explanatory diagram of the group table of the communication apparatus (SW1) according to the first embodiment;

FIG. 5 is an explanatory diagram of the assertion table of the communication apparatus (SW2) according to the first embodiment;

FIG. 6 is an explanatory diagram of the assertion DB according to the first embodiment;

FIG. 7 is an explanatory diagram of the assertion priority DB according to the first embodiment;

FIG. 8A is an explanatory diagram of the flow table included in the configuration DB according to the first embodiment;

FIG. 8B is an explanatory diagram of the group table included in the configuration DB according to the first embodiment;

FIG. 9A is an explanatory diagram of the communication apparatus management table included in the topology DB according to the first embodiment;

FIG. 9B is an explanatory diagram of the topology table included in the topology DB according to the first embodiment;

FIG. 10 is a flowchart of assertion generation processing according to the first embodiment;

FIG. 11 is a flowchart of the blocking port judgement processing according to the first embodiment;

FIG. 12 is a flowchart of the assertion entry generation processing according to the first embodiment;

FIG. 13 is a flowchart of assertion DB priority update processing according to the first embodiment;

FIG. 14 is a flowchart of assertion table update processing according to the first embodiment;

FIG. 15 is a state transition diagram of the communication apparatus 100 according to the first embodiment;

FIG. 16 is a flowchart of failure detection processing by the communication apparatus according to the first embodiment;

FIG. 17 is a flowchart of failure determination processing according to the first embodiment;

FIG. 18 is a flowchart of failure avoidance processing according to the first embodiment;

FIG. 19 is a flowchart of the failure identification processing according to the first embodiment;

FIG. 20 is a flowchart of the redundant failure processing according to the first embodiment;

FIG. 21 is a flowchart of the loop failure processing according to the first embodiment;

FIG. 22 is a flowchart of the ring failure point identification processing according to the first embodiment;

FIG. 23 is a flowchart of routing failure processing according to the first embodiment;

FIG. 24 is a flowchart of link failure processing according to the first embodiment;

FIG. 25 is a flowchart of path failure point identification processing according to the first embodiment;

FIG. 26 is a block diagram for illustrating a configuration of a communication system according to a second embodiment;

FIG. 27 is a flowchart of assertion table generation processing according to the second embodiment;

FIG. 28 is a flowchart of the assertion entry priority update processing according to the second embodiment.

### DETAILED DESCRIPTION OF THE PREFERRED EMBODIMENTS

Now, embodiments of this invention are described referring to the accompanying drawings. The same reference numerals represent the same components or equivalent components through the drawings. For the sake of descriptive convenience, suffixes may be added to reference numerals to distinguish the same components or equivalent components from one another.

This invention is not to be construed by limiting the invention to the content described in the following embodiments. A person skilled in the art would easily recognize that the specific elements described in the following embodiments may be changed within the scope of the concept and the gist of this invention.

Terms in this specification etc. such as “first”, “second”, “third”, and the like are added in order to identify component elements. Those terms do not necessarily limit the number or the order of the component elements.

The position, size, shape, range, and the like of each component illustrated in the drawings etc. are for facilitating understanding of the invention, and may not represent the actual position, size, shape, range, and the like. Therefore, this invention is not necessarily limited to the positions, sizes, shapes, ranges, and the like illustrated in the drawings etc.

The publications, patents, and patent applications cited in this specification themselves constitute a part of the description of this specification.

### First Embodiment

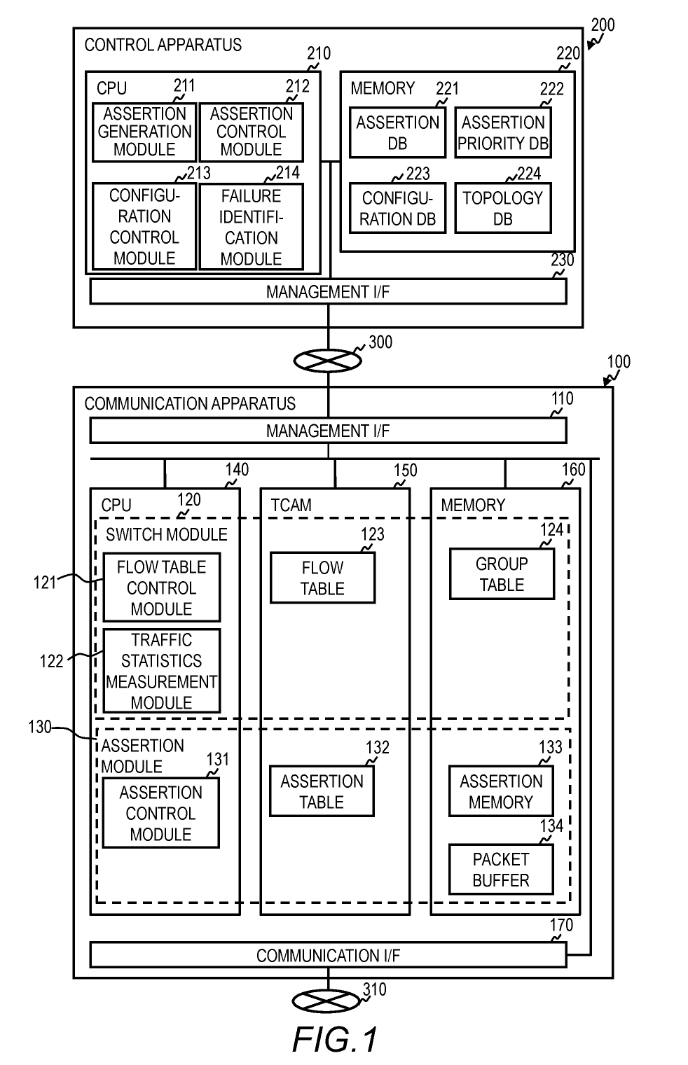

A first embodiment of this invention is described with reference to FIG. 1 to FIG. 25.

FIG. 1 is a block diagram for illustrating a configuration of a communication system according to the first embodiment.

The communication system according to this embodiment includes a communication apparatus 100 and a control apparatus 200. The communication apparatus 100 and the control apparatus 200 are coupled to each other via a control network 300. The communication apparatus 100 are coupled to each other via a network 310 constructed from a plurality of communication apparatuses 100. The number of communication apparatus 100 and the number of control apparatus 200 included in the communication system according to this embodiment are not limited to the numbers illustrated in FIG. 1.

Each communication apparatus 100 is configured to transmit and receive data to and from communication apparatus coupled thereto. Each communication apparatus 100 includes a management I/F 110, a switch module 120, an assertion module 130, and a communication I/F 170. The management I/F 110 is an interface configured to couple the communication apparatus 100 to the control network 300 to which the control apparatus 200 is coupled. The communication I/F 170 is an interface configured to couple the communication apparatus 100 to the network 310 to which another communication apparatus and the like are coupled. The management I/F 110 and the communication I/F 170 are configured to couple interfaces of the same type, such as Ethernet, InfiniBand (trademark), or the like, to each other.

The switch module 120 includes a flow table control module 121, a traffic statistics measurement module 122, a flow table 123, and a group table 124. The switch module 120, which includes a function of an OpenFlow (trademark) switch, is configured to transfer received data by referring to the flow table 123.

Further, the assertion module 130 includes an assertion control module 131, an assertion table 132, an assertion memory 133, and a packet buffer 134. The assertion module 130 is configured to judge whether or not a failure has occurred based on the received data and the assertion table 132.

In addition, the communication apparatus 100 includes a central processing unit (CPU) 140, a ternary content-addressable memory (TCAM) 150, and a memory 160. The CPU 140 includes the flow table control module 121, the traffic statistics measurement module 122, and the assertion control module 131. The TCAM 150 is configured to store the flow table 123 and the assertion table 132. The memory 160 includes the group table 124, the assertion memory 133, and the packet buffer 134.

First, a configuration of the switch module 120 is described.

The flow table control module 121 is configured to register a flow entry in the flow table 123 based on an instruction from the control apparatus 200, and to delete a flow entry from the flow table 123 based on an instruction from the control apparatus 200. The traffic statistics measurement module 122 is configured to measure statistical information on the data received by the communication apparatus 100. The statistical information on the received data is, for example, the number of packets, the number of bytes, and the like. The flow table control module 121 and the traffic statistics measurement module 122 are each realized by the CPU 140 executing programs. However, the flow table control module 121 and the traffic statistics measurement module 122 are not limited to this, and may also be realized by a hardware circuit such as a field-programmable gate array (FPGA) or an application-specific integrated circuit (ASIC).

In the flow table 123, a flow entry including a condition relating to the received data, an action to be taken on data matching the condition, and statistical information on data matching the condition is registered. The communication apparatus 100 is configured to transfer, when data has been received, the received data to another communication apparatus and the like by referring to the flow table 123, retrieving the flow entry matching the received data, and executing the action in the retrieved flow entry. The flow table 123 is described in more detail with reference to FIG. 3.

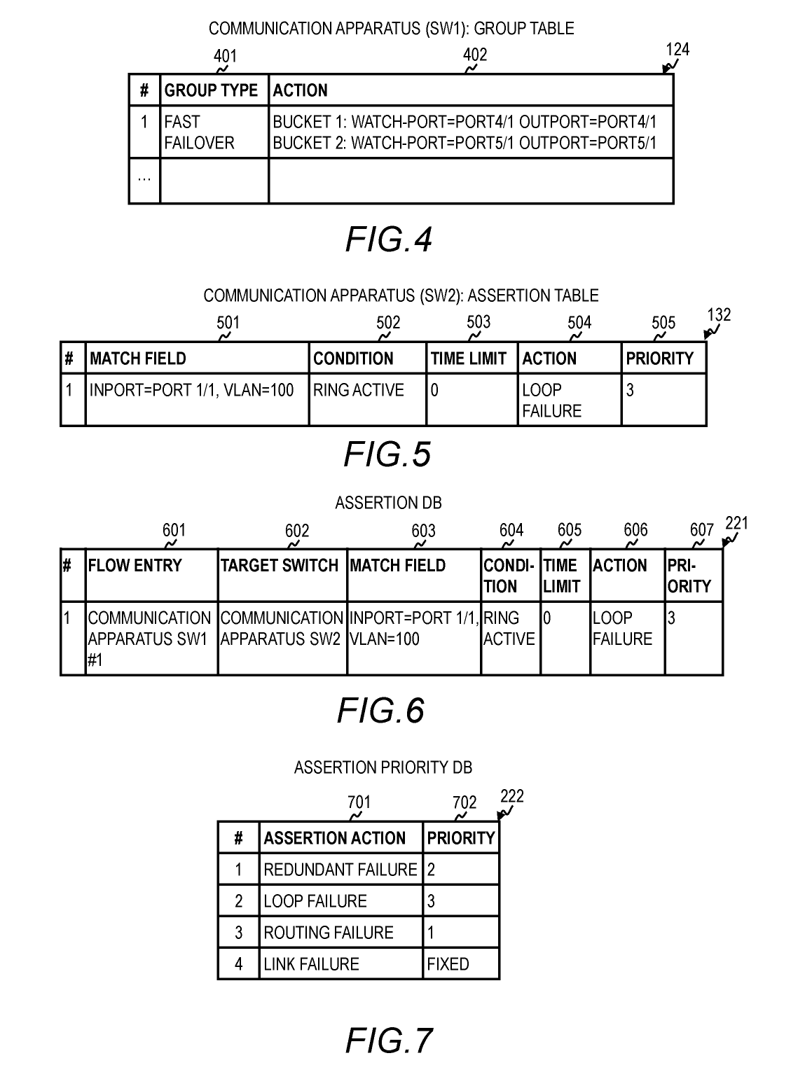

In the group table 124, detailed information on the action in the flow entry registered in the flow table 123 is registered. The group table 124 is described in more detail with reference to FIG. 4.

Next, a configuration of the assertion module 130 is described.

The assertion control module 131 is configured to register an entry in the assertion table 132, and to delete an entry from the assertion table 132. Further, the assertion control module 131 is configured to control the packet buffer 134 when a failure has been detected. The assertion control module 131 is realized by the CPU 140 executing a program. However, the assertion control module 131 is not limited to this, and may also be realized by a hardware circuit such as an FPGA or an ASIC.

In the assertion table 132, a condition (action) for detecting a failure relating to the received data is registered. When the communication apparatus 100 has received data, first, the assertion module 130 refers to the assertion table 132, and judges whether or not a failure has occurred by judging whether or not the received data matches the condition registered in the assertion table 132. When it is judged by the assertion module 130 that a failure has not occurred, the switch module 120 refers judged to the flow table 123, and transfers the received data. The assertion table 132 is described in more detail with reference to FIG. 5.

In the assertion memory 133, the assertions having a possibility of being registered in the assertion table 132 are registered.

The assertion table 132 is stored in the TCAM 150 in order to speed up the processing for retrieving the condition matching the received data. Typically, the TCAM 150 is expensive and has a high power consumption. Therefore, there are difficulties in using a TCAM 150 having a large storage capacity. In this invention, the assertions are registered in the assertion memory 133, which is included in the memory 160 that is cheaper and has a larger capacity than the TCAM 150. The assertions to be registered in the assertion table 132 are decided based on a priority of the assertions, and the decided assertions are written in the assertion table 132. As a result, because assertions having a high priority are written in the assertion table 132, an increase in the manufacturing costs of the communication apparatus 100 can be prevented while employing a TCAM 150 having the same storage capacity as in the related art.

When the assertion module 130 detects a packet suspected of being a failure in the packet buffer 134, that packet is stored until the failure of that packet is determined.

Next, the control apparatus 200 is described.

The control apparatus 200 includes a CPU 210, a memory 220, a management I/F 230, an input device (not shown), and an output device (not shown). The input device is, for example, a keyboard, a mouse, or the like. The output device is, for example, a display or the like. The management I/F 230 is an interface configured to be coupled to the control network 300.

The CPU 210 includes an assertion generation module 211, an assertion control module 212, a configuration control module 213, and a failure identification module 214. The assertion generation module 211, the assertion control module 212, the configuration control module 213, and the failure identification module 214 are each realized by the CPU 210 executing programs. However, the assertion generation module 211, the assertion control module 212, the configuration control module 213, and the failure identification module 214 are not limited to this, and may also be realized by a hardware circuit such as an FPGA or an ASIC. The memory 220 is configured to store an assertion database (DB) 221, an assertion priority DB 222, a configuration DB 223, and a topology DB 224.

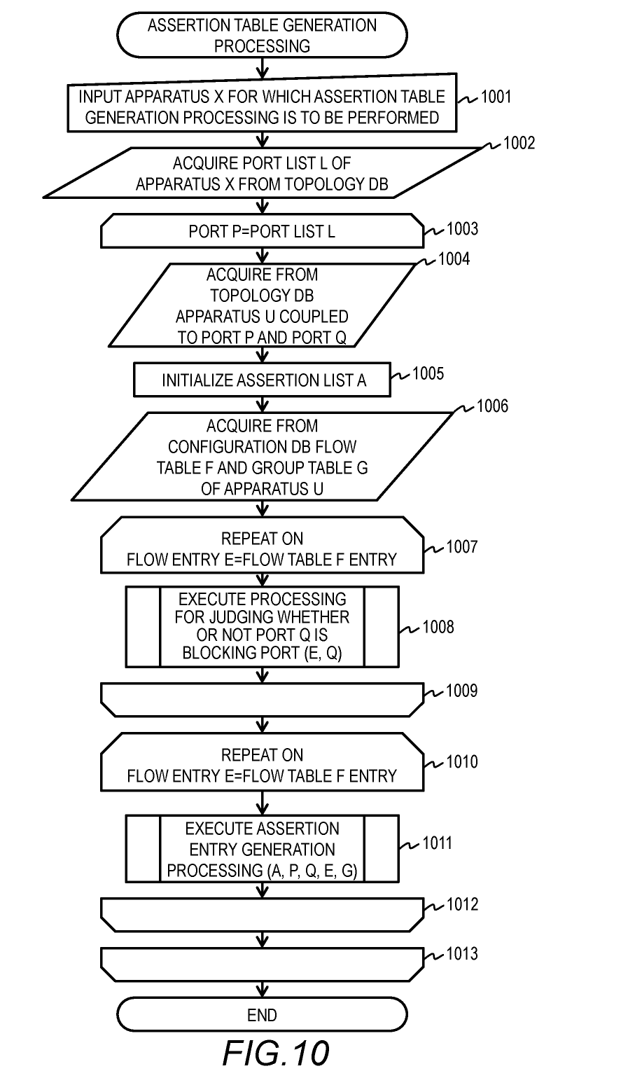

The assertion generation module 211 is configured to generate an assertion by referring to the flow table 123 and the group table 124 of the communication apparatus 100 coupled to the communication apparatus 100 for which an assertion is to be generated, and to register the generated assertion in the assertion DB 221. The generation processing performed by the assertion generation module 211 is described in more detail with reference to FIG. 10 to FIG. 12.

The assertion control module 212 is configured to manage the assertions registered in the assertion table 132 of the communication apparatus 100, and to collect statistical information on the data received by the communication apparatus 100. Further, the assertion control module 212 is configured to transmit to the communication apparatus 100 via the management I/F 230 an instruction for the assertions registered in the assertion DB 221 to be registered in the assertion memory 133.

The configuration control module 213 is configured to transmit to the communication apparatus 100 via the management I/F 230 an instruction for the content of the flow table and the content of the group table of the communication apparatus 100 registered in the configuration DB 223 to be registered in the flow table 123 and the group table 124 of the communication apparatus 100.

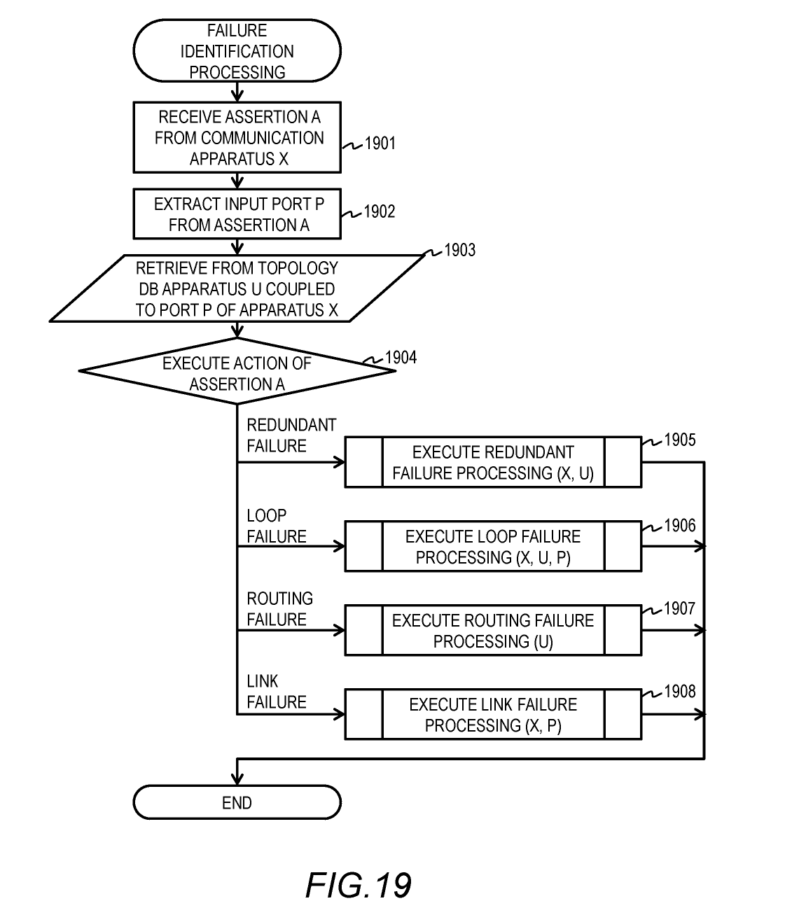

The failure identification module 214 is configured to refer, when the communication apparatus 100 has detected a failure, to the topology DB 224 to identify a location at which the failure occurred. The failure identification processing performed by the failure identification module 214 is described in more detail with reference to FIG. 19 to FIG. 25.

In the assertion DB 221, the assertions to be registered in the assertion memory 133 of each communication apparatus 100 are registered. The assertion DB 221 is described in more detail with reference to FIG. 6. In the assertion priority DB 222, an initial value of the priority corresponding to an assertion type is registered. The assertion priority DB 222 is described in more detail with reference to FIG. 7. The initial value is freely set by an administrator. Typically, the administrator sets the assertion priority DB 222 so that assertion types having a larger influence on the network when a failure has occurred have a higher initial value.

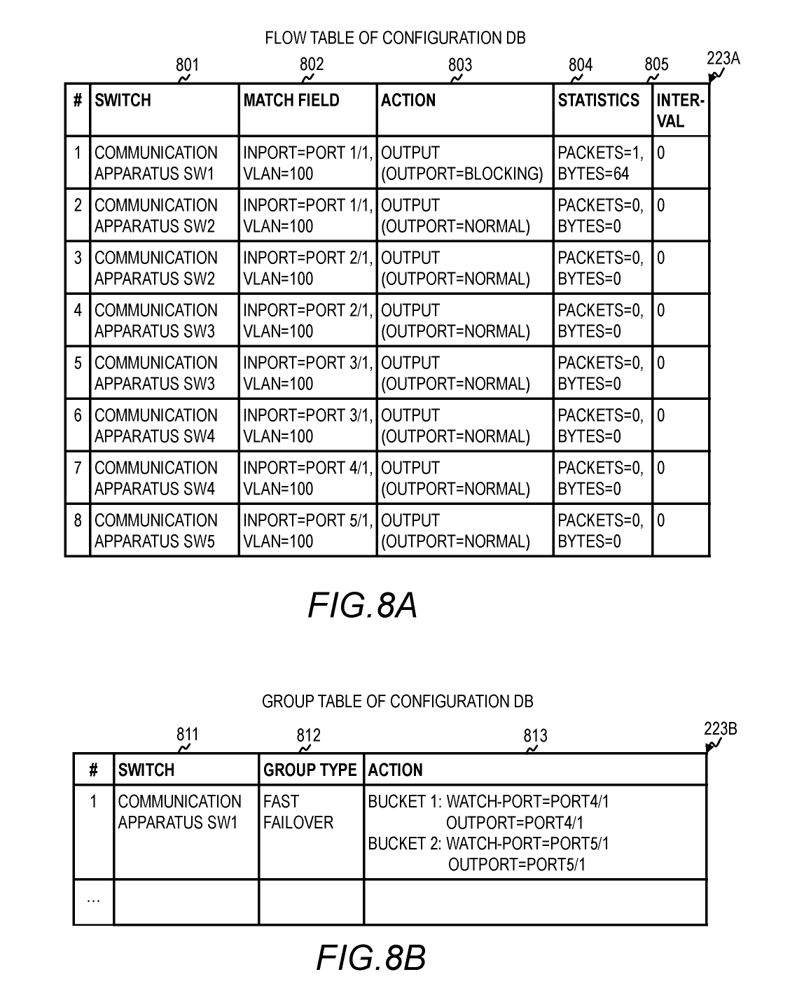

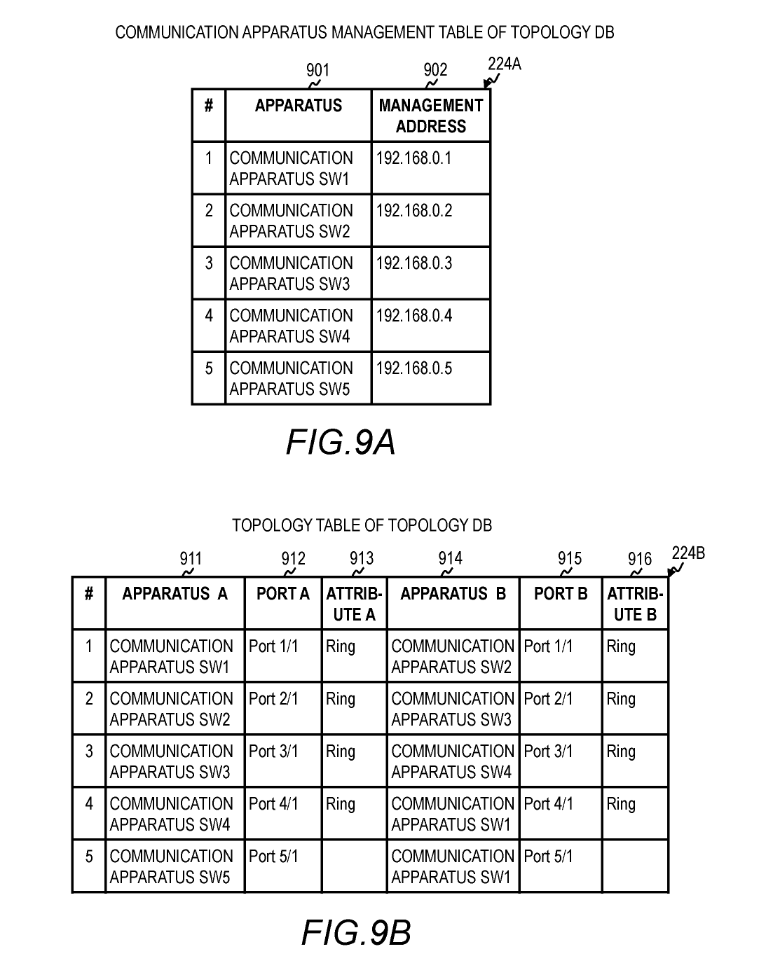

In the configuration DB 223, the content of the flow table 123 and the content of the group table 124 of the communication apparatus 100 are registered. The configuration DB 223 is described in more detail with reference to FIG. 8. In the topology DB 224, topology data indicating a coupling relationship of the communication apparatus 100 is registered. The topology DB 224 is described in more detail with reference to FIG. 9.

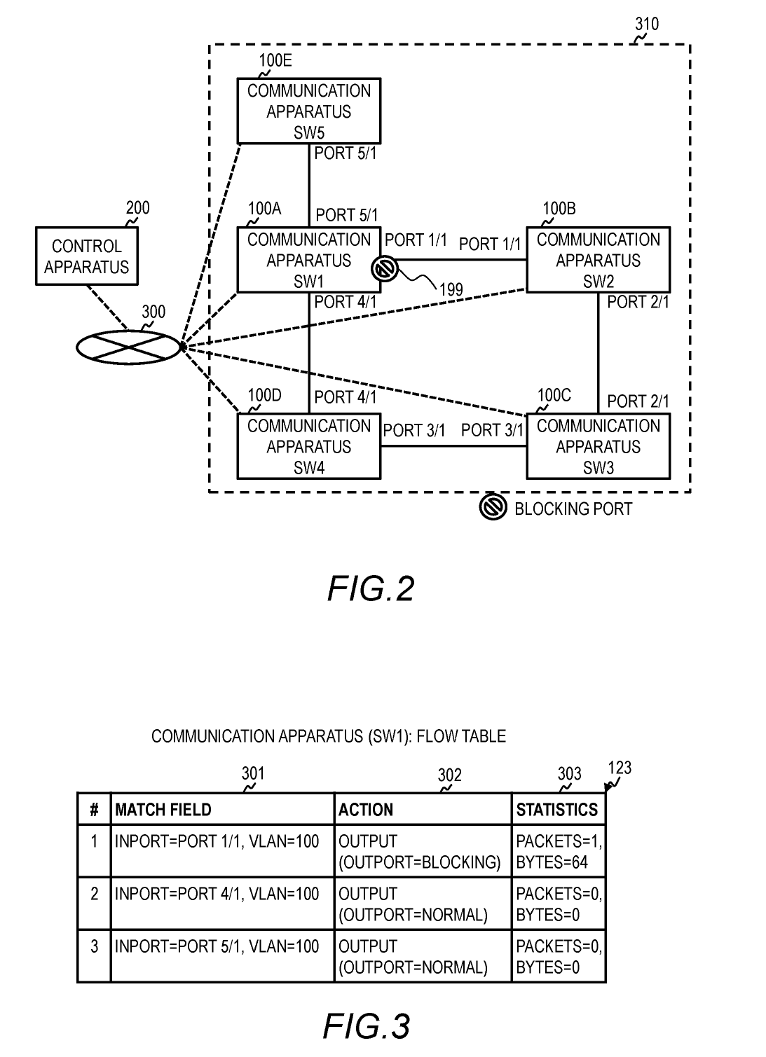

FIG. 2 is an explanatory diagram of a configuration example of the network 310 according to the first embodiment.

The network 310 is constructed from a communication apparatus (SW1) 100A to a communication apparatus (SW5) 100E. Each communication apparatus (SW1) 100A to communication apparatus (SW5) 100E is coupled to the control apparatus 200 via the control network 300.

In FIG. 2, a Port 1/1 of the communication apparatus (SW1) 100A and a Port 1/1 of the communication apparatus (SW2) 100B are coupled, a Port 2/1 of the communication apparatus (SW2) 100B and a Port 2/1 of the communication apparatus (SW3) 100C are coupled, a Port 3/1 of the communication apparatus (SW3) 100C and a Port 3/1 of the communication apparatus (SW4) 100D are coupled, a Port 4/1 of the communication apparatus (SW4) 100D and a Port 4/1 of the communication apparatus (SW1) 100A are coupled, and a Port 5/1 of the communication apparatus (SW5) 100E and a Port 5/1 of the communication apparatus (SW1) 100A are coupled.

The topology of the network 310 constructed from the communication apparatus (SW1) 100A to the communication apparatus (SW5) 100E is a ring topology, in which the Port 1/1 of the communication apparatus (SW1) 100A operates as a blocking port, and normally, the Port 1/1 of the communication apparatus (SW2) 100B does not receive data from the Port 1/1 of the communication apparatus (SW1) 100A.

FIG. 3 is an explanatory diagram of the flow table 123 of the communication apparatus (SW1) 100A according to the first embodiment.

The flow table 123 includes a Match Field 301, an Action 302, and a Statistics 303. In the Match Field 301, conditions are registered. In the Action 302, the processing content to be performed when the data received by the communication apparatus 100 matches the condition registered in the Match Field 301 is registered. In the Statistics 303, statistical information on the data matching the condition registered in the Match Field 301 is registered. The Statistics 303 is updated by the traffic statistics measurement module 122. The content of the Match Field 301, the Action 302, and the Statistics 303 is based on OpenFlow.

In a flow entry “#1”, it is defined that data having the Port 1/1 as an input port and “100” as a virtual local area network (VLAN) is to be transferred to an output port “Blocking”. The output port “Blocking” is defined as a special port in the ring topology. During normal operation, packet output of the received data is stopped, but when there has been a ring switch, the received data is transferred based on an L2 switch's forwarding database (FDB), in the same manner as for the output port “Normal”. Specifically, when the FDB has not yet learned the output port, the received data floods the ports having the same VLAN defined as an input port condition, and when the FDB has learned the output port, the received data is transferred to the learned output port.

In a flow entry “#2”, it is defined that data having the Port 4/1 as an input port and “100” as a VLAN is to be transferred to an output port “Normal”. In the OpenFlow specification, transfer to a “Normal” address is defined as being a transfer relying on the communication apparatus 100. In this embodiment, transfer to the “Normal” address transfers the received data based on the L2 switch's FDB.

FIG. 4 is an explanatory diagram of the group table 124 of the communication apparatus (SW1) 100A according to the first embodiment.

The group table 124 includes a Group Type 401 and an Action 402.

In the Group Type 401, the group type is registered. In the Action 402, the group action is registered. The content of the Group Type 401 and the Action 402 is based on OpenFlow.

The communication apparatus (SW1) 100A is configured to refer, when the group type is registered in the Action 302 of the flow entry registered in the flow table 123, to the group table 124, and to execute on the received data the processing content of the action registered in the Action 402 of the entry in which the applicable group type is registered in the Group Type 401.

In an entry “#1”, an action having “Fast Failover” as the group type indicates that, during normal operation, the Port 4/1 is watched and the output port is 4/1, and when a failure has occurred, the Port 5/1 is watched and the output port is 5/1.

FIG. 5 is an explanatory diagram of the assertion table 132 of the communication apparatus (SW2) 100B according to the first embodiment.

The assertion table 132 includes a Match Field 501, a Condition 502, a Time Limit 503, an Action 504, and a Priority 505. The entries registered in the assertion table 132 are referred to as assertions.

In the Match Field 501, conditions that relate to the received data and that are for detecting a failure are registered. In the Condition 502, conditions that relate to a topology state and that are for detecting a failure are registered. For example, Ring Active, Ring Standby, Redundant Active, Redundant Standby, or the like is registered in the Condition 502. Ring Active indicates that the ring topology is in a normal state. Ring Standby indicates that the ring topology has switched to a redundant system. Redundant Active indicates that the topology of a redundant path is in a normal state. Redundant Standby indicates that the topology of the redundant path has switched to a redundant path. Further, when it is not necessary for the topology state to be a condition for detecting a failure, “Always” is registered in the Condition 502. In the case that “Time Limit” is registered in the Condition 502, the fact that data that should be received has not been received when the time registered in the Time Limit 503 has passed is used as a condition for detecting a failure.

In the Time Limit 503, as a condition for detecting a failure of periodically transmitted data, a reception interval and the like of the data are registered. It should be noted that when “0” is registered in the Time Limit 503, this indicates that consideration is not given to the reception interval and the like of data as a condition for detecting a failure.

In the Action 504, the failure type when there is a match with the conditions for detecting a failure registered in the Match Field 501, the Condition 502, and the Time Limit 503 is registered as the action. For example, Loop Failure, Redundant Failure, Routing Failure, Link Failure, or the like is registered in the Action 504. Loop Failure indicates a failure in which a loop has occurred in a network having a ring topology. Redundant Failure indicates that there has been a failed input in a redundant path in a network having a redundant path topology. Routing Failure indicates that there has been an improper transfer. Link Failure indicates that there has been a continuity failure.

In the Priority 505, the priority of the assertion is registered. The priority registered in the Priority 505 may be in any form that is capable of expressing a value indicating a relative priority among the assertions. In this embodiment, the value registered in the Priority 505 is a 16-bit unsigned integer of from 0 to 65,535 inclusive. The number 0 indicates that the applicable entry is always registered in the assertion table 132.

In the assertion table 132 of the communication apparatus (SW2) 100B shown in FIG. 5, as the condition (failure detection condition) for detecting a Loop Failure, a condition is registered in which the input port of the data received by the communication apparatus (SW2) 100B is the Port 1/1, the VLAN of that data is “100”, and the state of the topology when that data is received is Ring Active. As described above with reference to FIG. 2, when the Port 1/1 of the communication apparatus (SW2) 100B is set to Ring Active (during normal operation), data is not input. Thus, the failure detection condition includes information for identifying data not to be received by the communication apparatus 100 during normal operation. Further, as the information for identifying such data, the failure detection condition includes an identifier of the port to which data is not to be input during normal operation.

In the assertion table 132 of the communication apparatus 100, a failure detection condition including information for identifying data not to be received during normal operation is registered as an assertion entry. As a result, an unexpected failure of a communication apparatus 100 coupled to another communication apparatus 100, and an incorrect setting of the path by the administrator or the like can be detected. Further, even when a failure has occurred that is not detected by a test packet, that failure can be detected as long as the received data satisfies the failure detection condition. In addition, a failure can be easily identified by individually detecting a plurality of communication flows. Still further, because the failure detection condition includes an identifier of the port to which data is not to be input during normal operation, a failure that data that was not supposed to be input has been input, which is not detected by a test packet, can be detected.

Next, the various databases 221 to 224 of the control apparatus 200 are described with reference to FIG. 6 to FIG. 9B.

FIG. 6 is an explanatory diagram of the assertion DB 221 according to the first embodiment.

The assertion DB 221 includes a Flow Entry 601, a Target Switch 602, a Match Field 603, a Condition 604, a Time Limit 605, an Action 606, and a Priority 607.

In the Flow Entry 601, an identifier of the communication apparatus 100 storing the flow table 123 in which the flow entry used to generate an assertion is registered and an identifier of that flow entry are registered. In the Target Switch 602, an identifier of the communication apparatus 100 configured to set the assertion is registered. The Match Field 603 to the Priority 607 are the same as the Match Field 501 to the Priority 505 of the assertion table 132, and hence a description thereof is omitted here.

The assertion control module 212 is configured to set an assertion including information registered in the Match Field 603 to the Priority 607 in the communication apparatus 100 identified by the identifier registered in the Target Switch 602. Specifically, the assertion control module 212 is configured to refer to a communication apparatus management table 224A included in the topology DB 224 to acquire an address of the communication apparatus 100 identified by the identifier registered in the Target Switch 602. Then, the assertion control module 212 transmits from the management I/F 230 the assertion including the information registered in the Match Field 603 to the Priority 607 using the acquired address as a destination.

The assertions registered in the assertion DB 221 may be automatically generated by the assertion generation module 211, or may be manually generated by the administrator or the like for the purpose of a failsafe setting or debugging. When an assertion is to be manually set, the administrator or the like inputs the content of the assertion to the control apparatus 200 by using an input device such as a keyboard or a mouse.

FIG. 7 is an explanatory diagram of the assertion priority DB 222 according to the first embodiment.

The assertion priority DB 222 includes an Assertion Action 701 and a Priority 702.

In the Assertion Action 701, the failure type registered in the Condition 502 of the assertion table 132 is registered. In the Priority 702, the priority of each failure type is registered. The priority registered in the Priority 702 is registered by the administrator in consideration of, for example, the impact of the failure and the probability of each failure occurring.

The assertion priority DB 222 is utilized when an assertion is generated by the assertion generation module 211.

FIG. 8A is an explanatory diagram of the flow table 223A included in the configuration DB 223 according to the first embodiment.

The content of the flow table 123 held by each communication apparatus 100 is registered in the flow table 223A included in the configuration DB 223.

The flow table 223A includes a Switch 801, a Match Field 802, an Action 803, a Statistics 804, and an Interval 805.

Registered in the Switch 801 is an identifier of the communication apparatus 100 holding the flow table 123 in which the flow entry registered in the entry of the flow table 223A is registered. The Match Field 802 to the Statistics 804 are the same as the Match Field 301 to the Statistics 303 of the flow table 123, and hence a description thereof is omitted here. In the Interval 805, a transmission interval of the data matching the condition registered in the Match Field 802 is registered.

The Interval 805 is utilized only when the assertion generation module 211 generates an assertion. Therefore, the Interval 805 is not included in the flow table 123 held by the communication apparatus 100. As a result of the assertion being generated in consideration of the transmission interval registered in the Interval 805, periodically transmitted data may also be verified. Further, the Statistics 804 is updated by the assertion control module 212.

The configuration control module 213 is configured to refer to the communication apparatus management table 224A included in the topology DB 224 to acquire the address of the communication apparatus 100 identified by the identifier registered in the Switch 801. Then, the assertion control module 212 transmits from the management I/F 230 flow information including the information registered in the Match Field 802 and the Action 803 using the acquired address as a destination, and set the flow information in each communication apparatus 100. The control apparatus 200 is configured to collect the value of the Statistics 303 in the flow table 123 updated by the communication apparatus 100, and register the collected value in the Statistics 804 of the flow table 223A in the configuration DB 223. The value of the Statistics 804 is not set when setting the flow table 223A.

FIG. 8B is an explanatory diagram of the group table 223B included in the configuration DB 223 according to the first embodiment.

The content of the group table 124 held by each communication apparatus 100 is registered in the group table 223B included in the configuration DB 223.

The group table 223B includes a Switch 811, a Group Type 812, and an Action 813.

Registered in the Switch 811 is an identifier of the communication apparatus 100 holding the group table 124 registered in the entry of the group table 223B. The Group Type 812 and the Action 813 are the same as the Group Type 401 and the Action 402 of the group table 124, and hence a description thereof is omitted here.

The configuration control module 213 is configured to refer to the communication apparatus management table 224A included in the topology DB 224 to acquire the address of the communication apparatus 100 identified by the identifier registered in the Switch 811. Then, the assertion control module 212 transmits from the management I/F 230 group information including the information registered in the Group Type 812 and the Action 813 using the acquired address as a destination, and set the group table in the communication apparatus 100.

The flow table 223A and the group table 223B included in the configuration DB 223 are set by the administrator or the like.

FIG. 9A is an explanatory diagram of the communication apparatus management table 224A included in the topology DB 224 according to the first embodiment.

In the communication apparatus management table 224A, an association between the identifier of each communication apparatus 100 managed by the control apparatus 200 and the address of the communication apparatus 100 is registered.

The communication apparatus management table 224A includes an Apparatus 901 and a Management Address 902. In the Apparatus 901, an identifier of each communication apparatus 100 managed by the control apparatus 200 is registered. In the Management Address 902, an address for managing each communication apparatus 100 managed by the control apparatus 200 is registered. The address for managing the communication apparatus 100 is necessary when the assertion control module 212, the configuration control module 213, and the failure identification module 214 access the communication apparatus 100.

FIG. 9B is an explanatory diagram of the topology table 224B included in the topology DB 224 according to the first embodiment.

In the topology table 224B, coupling relationships between a plurality of communication apparatuses 100 are registered. The topology table 224B includes an Apparatus A 911, a Port A 912, an Attribute A 913, an Apparatus B 914, a Port B 915, and an Attribute B 916.

In the Apparatus A 911, an identifier of the coupling source communication apparatus 100 is registered. In the Apparatus B 914, an identifier of the coupling destination communication apparatus 100 is registered. In the Port A 912, an identifier of the port of the coupling source communication apparatus 100 coupled to the coupling destination communication apparatus 100 is registered. In the Port B 915, an identifier of the port of the coupling destination communication apparatus 100 coupled to the coupling source communication apparatus 100 is registered. In the Attribute A 913 and the Attribute B 916, the network topology between the coupling source communication apparatus 100 and the coupling destination communication apparatus 100 is registered.

It should be noted that the coupling source communication apparatus 100 and the coupling destination communication apparatus 100 are bi-directionally coupled.

The communication apparatus management table 224A and the topology table 224B included in the topology DB 224 are set by the administrator or the like.

Next, assertion table generation processing executed by the assertion generation module 211 is described with reference to FIG. 10 to FIG. 12.

FIG. 10 is a flowchart of assertion generation processing according to the first embodiment.

First, the assertion generation module 211 receives from the administrator or the like an input of the identifier of the communication apparatus 100 (communication apparatus X) for which the assertion table 132 is to be generated (1001).

Next, the assertion generation module 211 refers to the topology table 224B included in the topology DB 224, and acquires the identifiers of all the ports of the processing target communication apparatus X as a port list L (1002). Specifically, the assertion generation module 211 acquires the identifier of the port registered in the Port A 912 of the entry in which the identifier of the processing target communication apparatus X is registered in the Apparatus A 911 of the topology table 224B, and acquires the identifier of the port registered in the Port B 915 of the entry in which the identifier of the processing target communication apparatus X is registered in the Apparatus B 914.

Next, the assertion generation module 211 selects the identifier of the processing target port (port P) from among the identifiers of the ports included in the port list L acquired in Step 1002, and executes the processing of Steps 1004 to 1013 (1003). The processing of Steps 1004 to 1013 is repeated until the processing has been executed on the identifiers of all the ports included in the port list L.

The assertion generation module 211 refers to the topology table 224B included in the topology DB 224, and acquires the identifier of a communication apparatus U coupled to the processing target port P selected by the processing of Step 1003 on the processing target communication apparatus X and the identifier of a port Q of the communication apparatus U (1004).

Specifically, the assertion generation module 211 acquires, when there is an entry in which the identifier of the processing target communication apparatus X is registered in the Apparatus A 911 of the topology table 224B, and the identifier of the processing target port P is registered in the Port A 912 of the topology table 224B, the identifier registered in the Apparatus B 914 of that entry as the identifier of the communication apparatus U, and the identifier registered in the Port B 915 of that entry as the identifier of the port Q. Similarly, the assertion generation module 211 acquires, when there is an entry in which the identifier of the processing target communication apparatus X is registered in the Apparatus B 914 of the topology table 224B, and the identifier of the processing target port P is registered in the Port B 915 of the topology table 224B, the identifier registered in the Apparatus A 911 of that entry as the identifier of the communication apparatus U, and the identifier registered in the Port A 912 of that entry as the identifier of the port Q.

Next, the assertion generation module 211 initializes an assertion list (variable A) for storing the assertions of the processing target communication apparatus X (1005).

Next, the assertion generation module 211 acquires, as a flow table F, all the flow entries corresponding to the communication apparatus U from the flow table 223A included in the configuration DB 223, and acquires as a group table G all the entries corresponding to the communication apparatus U from the group table 223B (1006).

Specifically, the assertion generation module 211 refers to the flow table 223A and acquires, as the flow table F, all the entries in which the identifier of the communication apparatus U is registered in the Switch 801. Further, the assertion generation module 211 also refers to the group table 223B and acquires, as the group table G, all the entries in which the identifier of the communication apparatus U is registered in the Switch 811.

Next, the assertion generation module 211 selects a processing target flow entry E from the flow table F acquired by the processing of Step 1006, and executes the processing of Steps 1008 and 1009 (1007). The processing of Steps 1008 and 1009 is repeated until the processing has been executed on all the flow entries acquired by the processing of Step 1006.

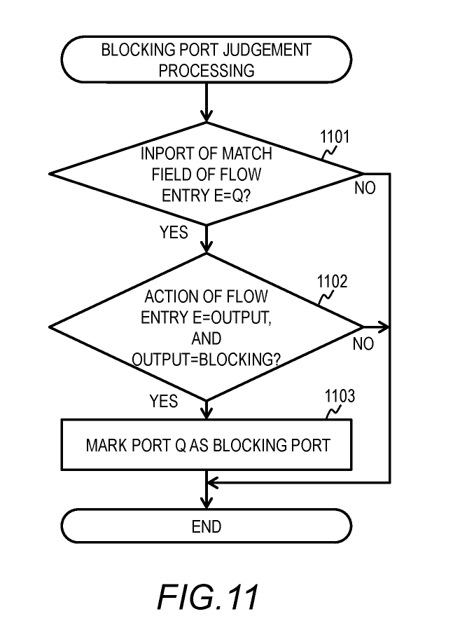

The assertion generation module 211 refers to the flow entry E selected by the processing of Step 1007, and executes blocking port judgement processing for judging whether or not the port Q of the communication apparatus U is a blocking port (1008). In the blocking port judgement processing, the identifier of the flow entry E and the identifier of the port Q are input as parameters. The blocking port judgement processing is described in more detail with reference to FIG. 11.

When the processing of Step 1008 has not been executed on all the flow entries acquired by the processing of Step 1006, the assertion generation module 211 returns the processing to Step 1007, and selects a new processing target flow entry E. When the processing of Step 1008 has been executed on all the flow entries acquired by the processing of Step 1006, the assertion generation module 211 advances the processing to Step 1010 (1009).

Based on the processing of Steps 1007 to 1009, the assertion generation module 211 judges whether or not, for each flow entry of the communication apparatus U, the port Q is a blocking port.

When the processing of Step 1008 has been executed on all the flow entries acquired by the processing of Step 1006, the assertion generation module 211 selects a processing target flow entry E from the flow table F acquired by the processing of Step 1006, and executes the processing of Steps 1011 and 1012 (1010). The processing of Steps 1011 and 1012 is repeated until the processing has been executed on all the flow entries acquired by the processing of Step 1006.

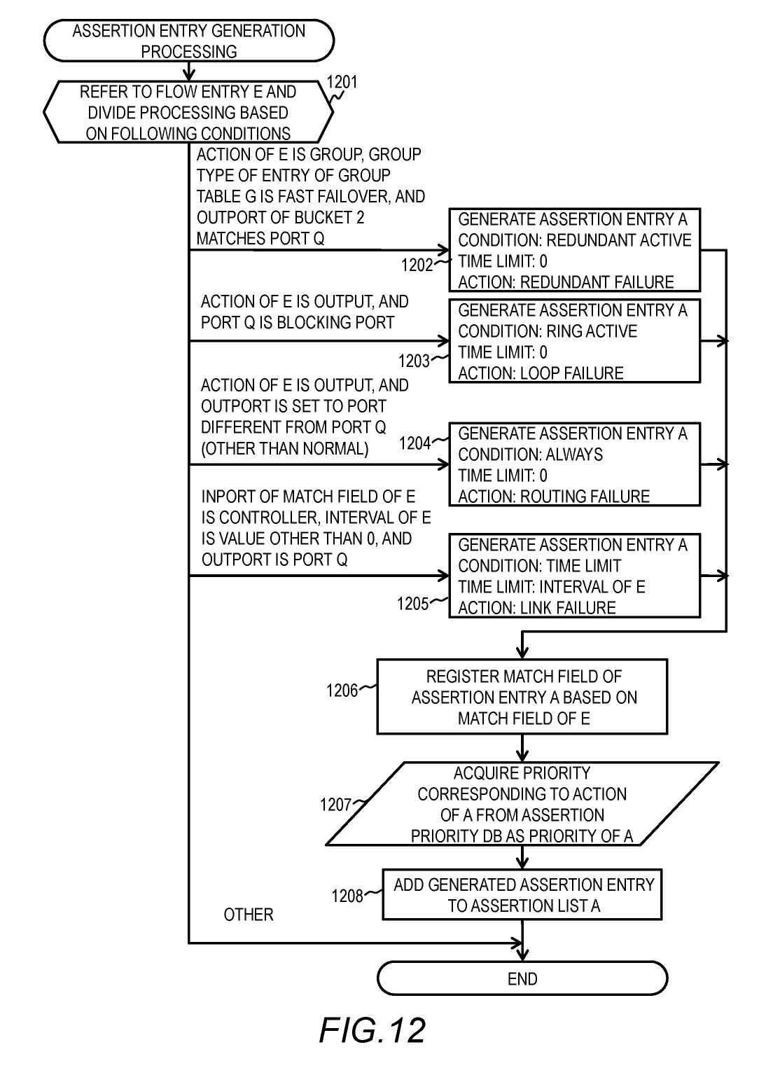

The assertion generation module 211 executes assertion entry generation processing for generating an assertion entry of the communication apparatus X based on the flow entry E selected by the processing of Step 1010 (1011). The assertion entry generation processing is described in more detail with reference to FIG. 12.

Next, when the processing of Step 1011 has not been executed on all the flow entries acquired by the processing of Step 1006, the assertion generation module 211 returns the processing to Step 1010, and selects a new processing target flow entry E. When the processing of Step 1010 has been executed on all the flow entries acquired by the processing of Step 1006, the assertion generation module 211 advances the processing to Step 1013 (1012).

In the processing of Step 1013, when the processing of Steps 1004 to 1012 has been executed on the identifiers of the ports included in the port list L acquired by the processing of Step 1002, the assertion generation module 211 finishes the assertion table generation processing. When the processing of Steps 1004 to 1012 has been not executed on the identifiers of the ports included in the port list L acquired by the processing of Step 1002, the assertion generation module 211 returns the processing to Step 1003, and selects the identifier of a new processing target port (port P) from the identifiers of the ports included in the port list L.

FIG. 11 is a flowchart of the blocking port judgement processing according to the first embodiment. The blocking port judgement processing is processing for judging whether or not the port Q of the communication apparatus U coupled to the port P of the communication apparatus X for which the assertion table 132 is to be generated is a blocking port. In the blocking port judgement processing, the identifier of the flow entry E and the identifier of the port Q are used as parameters.

First, the assertion generation module 211 judges whether or not the input port of the Match Field 802 of the flow entry E is the identifier of the port Q (1101).

When it is judged in the processing of Step 1101 that the input port of the Match Field 802 of the flow entry E is not the identifier of the port Q (1101: No), because this means that the flow entry E is not related to the port Q, the assertion generation module 211 finishes the blocking port judgement processing.

On the other hand, when it is judged in the processing of Step 1101 that the input port of the Match Field 802 of the flow entry E is the identifier of the port Q (1101: Yes), the assertion generation module 211 judges whether or not Output is registered in the Action 803 of the flow entry E, and whether or not output port “Blocking” is registered in the Action 803 (1102).

In the processing of Step 1102, when Output is registered in the Action 803 of the flow entry E, and output port “Blocking” is not registered in the Action 803, because this means that the port Q is not a blocking port, the assertion generation module 211 finishes the blocking port judgement processing.

In contrast, in the processing of Step 1102, when Output is registered in the Action 803 of the flow entry E, and output port “Blocking” is registered in the Action 803, because this means that the port Q is a blocking port, the assertion generation module 211 marks the port Q as a blocking port, and finishes the blocking port judgement processing.

FIG. 12 is a flowchart of the assertion entry generation processing according to the first embodiment. The assertion entry generation processing is processing for generating, based on the flow entry E of the communication apparatus U coupled to the port P, an assertion entry of the port P for the communication apparatus X for which the assertion table 132 is to be generated. The assertion entry generation processing uses the assertion list A, the identifier of the port P of the communication apparatus X, the identifier of the port Q of the communication apparatus U, the flow entry E, and the group table G as parameters.

First, the assertion generation module 211 refers to the flow entry E and divides the processing based on first to fifth conditions (1201).

The first condition is now described. The first condition is that an indication to refer to a group table is registered in the Action 803 of the flow entry E, Fast Failover is registered in the Group Type 812 of the group table G, and the output port of a Bucket 2 of the Action 813 of the group table G matches the port Q. When the flow entry E satisfies the first condition, the coupling between the port P of the communication apparatus X and the port Q of the communication apparatus U is a redundant connection via which data is communicated when a failure has occurred. During normal operation, data is not communicated via the redundant connection. Therefore, when data is input to the port P of the communication apparatus X during normal operation, this means that a redundancy-related failure has occurred. Therefore, when the flow entry E satisfies the first condition, the assertion generation module 211 generates an assertion entry a for detecting a redundancy-related failure (1202), and advances the processing to Step 1206.

In the assertion entry a generated by the processing of Step 1202, Redundant Active is registered in the Condition, 0 is registered in the Time Limit, and Redundant Failure is registered in the Action.

The second condition is now described. The second condition is that Output is registered in the Action 803 of the flow entry E, and, the port Q is a blocking port. When the flow entry E satisfies the second condition, this means that the port Q of the communication apparatus U coupled to the port P of the communication apparatus X is a blocking port. During normal operation, data is not input to the port P from the port Q. Therefore, when data is input to the port P during normal operation, this means that a loop failure has occurred in the ring topology. Therefore, when the flow entry E satisfies the second condition, the assertion generation module 211 generates an assertion entry a for detecting a loop failure in the ring topology (1203), and advances the processing to Step 1206.

In the assertion entry a generated by the processing of Step 1203, Ring Active is registered in the Condition, 0 is registered in the Time Limit, and Loop Failure is registered in the Action.

The assertion entry a generated when the first condition is satisfied and the assertion entry a generated when the second condition is satisfied are both for detecting a redundant network failure caused by the input of data to a standby system path during normal operation.

The third condition is now described. The third condition is that Output is registered in the Action 803 of the flow entry E, and, the output port is a setting other than Normal and is different from the port Q. When the flow entry E satisfies the third condition, because data is not output from the port Q of the communication apparatus U, data is not input from the port Q to the port P of the communication apparatus X. This means that when data has been input to the port P of the communication apparatus X, a routing failure has occurred at the communication apparatus U. Therefore, when the flow entry E satisfies the third condition, the assertion generation module 211 generates an assertion entry a for detecting a routing failure (1204), and advances the processing to Step 1206.

In the processing of Step 1204, the assertion generation module 211 registers Always in the Condition, 0 in the Time Limit, and Routing Failure in the Action.

The fourth condition is now described. The fourth condition is that the input port of the Match Field 802 of the flow entry E is Controller, a value other than 0 is registered in the Interval 805, and the output port is the port Q. When the flow entry E satisfies the fourth condition, data is input from the port Q to the port P of the communication apparatus X at a time interval indicated by the value registered in the Interval 805. This means that when data is not input to the port P from the port Q at that time interval, a link failure has occurred. Therefore, when the flow entry E satisfies the fourth condition, the assertion generation module 211 generates an assertion entry a for detecting a link failure (1205), and advances the processing to Step 1206.

In the assertion entry a generated by the processing of Step 1205, Time Limit is registered in the Condition, the value registered in the Interval 805 is registered in the Time Limit, and Link Failure is registered in the Action.

The fifth condition is now described. The fifth condition is that the flow entry E does not satisfy the first to fourth conditions. When the flow entry E satisfies the fifth condition, the assertion generation module 211 finishes the assertion entry generation processing.

When the processing of Steps 1202 to 1205 has been executed, the assertion generation module 211 registers the identifier of the port Q for the input port of the Match Field of the generated assertion entry a, and registers a value other than the value of the input port registered in the Match Field 802 of the flow entry E in the Match Field of the assertion entry a (1206).

Next, the assertion generation module 211 refers to the assertion priority DB 222, and acquires the priority registered in the Priority 702 of the entry in which the failure type registered in the Action of the assertion entry a is registered in the Assertion Action 701 (1207). Then, the assertion generation module 211 registers the priority acquired by the processing of Step 1207 in the Priority of the assertion entry a. In addition, the assertion generation module 211 registers the identifier of the communication apparatus U and the identifier of the flow entry E in the Flow Entry of the assertion entry a, and registers the identifier of the communication apparatus X in the Target Switch.

Next, the assertion generation module 211 adds the generated assertion entry a to the assertion list A (1208), and then finishes the assertion generation processing.

Based on the processing described above, the control apparatus 200 generates, in the case of generating an assertion of the communication apparatus X, an assertion entry when the flow entry E in the flow table F of the communication apparatus U coupled to a given port P of the communication apparatus X satisfies a predetermined condition. Further, the control apparatus 200 registers in the Match Field of the generated assertion entry the identifier of the port P of the communication apparatus X as a condition for detecting a failure. As a result, an assertion entry is automatically generated just by the administrator specifying the communication apparatus 100 for which the assertion table 132 is to be generated, which enables the burden on the administrator to be reduced. Further, compared with a manually generated assertion entry, a failure can be detected more accurately, and network reliability can be improved. In addition, because the generated assertion entry includes a priority corresponding to the failure type, the communication apparatus 100 are capable of writing the assertion entry in the assertion table 132 based on priority.

Next, the assertion generation processing illustrated in FIG. 10 is described in more detail with reference to FIG. 2.

In the processing of Step 1001, the identifier of the communication apparatus (SW2) 100B is input as the communication apparatus X for which the assertion table 132 is to be generated.

In the processing of Step 1002, the identifiers of the ports (Port 1/1 and Port 2/1) of the communication apparatus (SW2) 100B are acquired as the port list L.

In the processing of Step 1003, the Port 1/1 is selected as the identifier of the port P. In the processing of Step 1004, the communication apparatus (SW1) 100A coupled to the Port 1/1 of the communication apparatus (SW2) 100B is acquired as the communication apparatus U, and the Port 1/1 of the communication apparatus (SW1) 100A is acquired as the identifier of the port Q.

In the processing of Step 1005, the assertion list A is initialized. In the processing of Step 1006, as the flow table F of the communication apparatus (SW1) 100A, the “#1” flow entry in the flow table 223A shown in FIG. 8A and the “#1” entry in the flow table G shown in FIG. 8B are acquired.

In the processing of Step 1007, the “#1” flow entry in the flow table 223A shown in FIG. 8A is selected as the flow entry E. In the processing of Step 1008, a judgement is made regarding whether or not the Port 1/1 of the communication apparatus (SW1) is a blocking port by referring to the selected flow entry E.

The processing of Step 1008 is now described with reference to FIG. 11. In the processing of Step 1101, because the input port of the Match Field 802 of the “#1” flow entry in the flow table 223A shown in FIG. 8A is Port 1/1, a “Yes” judgement is made. In the processing of Step 1102, because Output is registered in the Action 803 of the “#1” flow entry in the flow table 223A shown in FIG. 8A, and the output port is “Blocking”, a “Yes” judgement is made. In the processing of Step 1103, the Port 1/1 is marked as a blocking port.

In the processing of Step 1009, because the processing Step 1008 has been executed on all the flow entries acquired by the processing of Step 1006, the processing advances to Step 1010.

In the processing of Step 1010, the “#1” flow entry in the flow table 223A shown in FIG. 8A is selected as the flow entry E. The processing of Step 1011 is now described with reference to FIG. 12. In the processing of Step 1201, for the “#1” flow entry in the flow table 223A shown in FIG. 8A, Output is registered in the Action 803, and the Port 1/1 is a blocking port. Therefore, the flow entry satisfies the second condition, and hence the processing advances to Step 1203. In the processing of Step 1203, an assertion entry a is generated in which Ring Active is registered in the Condition, 0 is registered in the Time Limit, and Loop Failure is registered in the Action 803.

Next, in the processing of Step 1206, because the input port of the Match Field 802 of the “#1” flow entry in the flow table 223A shown in FIG. 8A is the port Q (Port 1/1), there is no need to change, and hence the information registered in the Match Field 802 (Inport=Port 1/1, VLAN=100) is registered in the Match Field of the assertion entry a.

Next, in the processing of Step 1207, the priority “3” registered in the Priority 702 of the entry in which Loop Failure is registered in the Assertion Action 701 of the assertion priority DB 222 is acquired. Then, the priority “3” is registered in the Priority of the assertion entry a, the identifier of the communication apparatus (SW1) 100A and “#1” are registered in the Flow Entry, and the identifier of the communication apparatus (SW2) 100B is registered in the Target Switch. The assertion entry generation processing is then finished, and the processing advances to Step 1012 illustrated in FIG. 10.

In the processing of Step 1012, because the processing Step 1011 has been executed on all the flow entries acquired by the processing of Step 1006, the processing advances to Step 1013.

In the processing of Step 1013, because the processing of Steps 1004 to 1012 has not been executed on Port 2/1 included in the Port list L, the processing returns to Step 1003, and the Port 2/1 is selected as the port P.

In the processing of Step 1004, the communication apparatus (SW3) 100C coupled to the Port 2/1 of the communication apparatus (SW2) 100B is acquired as the communication apparatus U, and the Port 2/1 of the communication apparatus (SW3) 100C is acquired as the identifier of the port Q. It should be noted that the subsequent processing is executed based on the flow entry of the communication apparatus (SW3) 100C (the “#4” and “#5” flow entries in the flow table 223A shown in FIG. 8A). In this processing, the Port 2/1 of the communication apparatus (SW3) 100C is not a blocking port, and the “#4” and “#5” flow entries do not satisfy any of the first to fourth conditions but satisfy the fifth condition. Therefore, the assertion entry generation processing is finished without an assertion entry a being generated.

The “#1” assertion entry in the assertion DB 221 shown in FIG. 6 is generated based on the assertion generation processing described above.

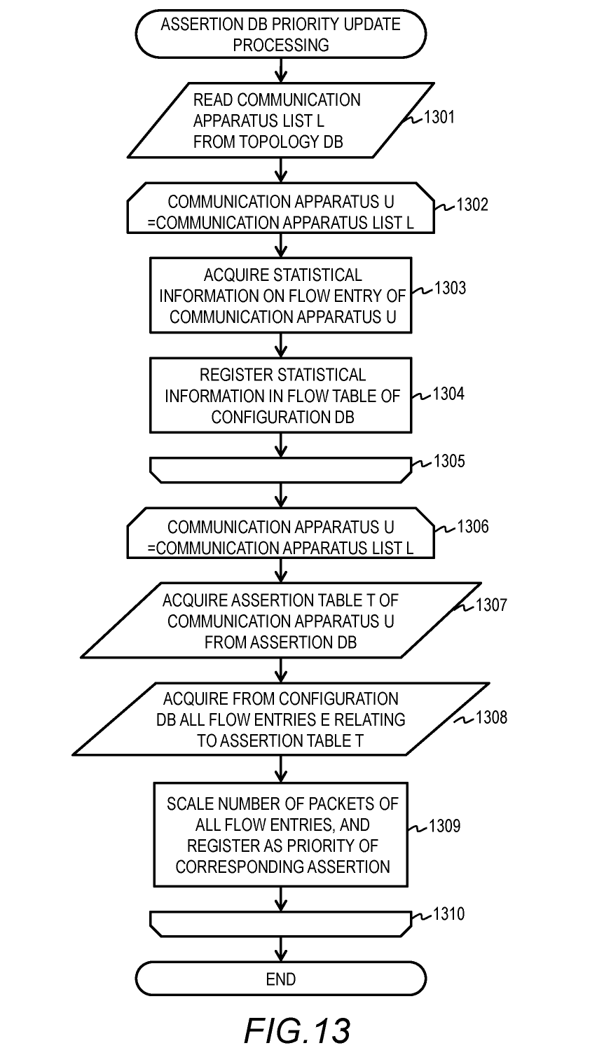

FIG. 13 is a flowchart of assertion DB priority update processing according to the first embodiment.

The assertion DB priority update processing, which is processing for updating the priority of an assertion registered in the assertion DB 221 based on the number of packets, is executed by the assertion control module 212 each predetermined time period.

First, the assertion control module 212 acquires a list (communication apparatus list L) of the identifiers of the communication apparatus 100 registered in the communication apparatus management table 224A of the topology DB 224 (1301).

Next, the assertion control module 212 selects an identifier of a communication apparatus 100 included in the communication apparatus list L acquired by the processing of Step 1301, and executes the processing of Steps 1303 to 1305 on the selected identifier of the communication apparatus 100 (communication apparatus U) (1302). The processing of Steps 1303 and 1304 is repeatedly executed on the identifiers of all the communication apparatus 100 included in the communication apparatus list L.

The assertion control module 212 refers to the communication apparatus management table 224A, acquires the address of the communication apparatus U, accesses the communication apparatus U having the acquired address, and acquires the statistical information registered in the Statistics 303 of the flow table 123 of the communication apparatus U (1303).

Next, the assertion control module 212 registers the statistical information on the communication apparatus U acquired by the processing of Step 1303 in the Statistics 804 of the flow table 223A of the configuration DB 223 (1304).

When the processing of Steps 1303 and 1304 has not been executed on the identifiers of all the communication apparatus 100 acquired in Step 1301, the assertion control module 212 returns the processing to Step 1302, and selects the identifier of a new communication apparatus 100. When the processing of Steps 1303 and 1304 has been executed on the identifiers of all the communication apparatus 100 acquired in Step 1301, the assertion control module 212 advances the processing to Step 1306 (1305).

Based on the processing of Steps 1302 to 1305, statistical information on all the communication apparatus 100 managed by the control apparatus 200 is acquired, and the acquired statistical information is registered in the flow table 223A included in the configuration DB 223.

Next, the assertion control module 212 selects an identifier of a communication apparatus 100 included in the communication apparatus list L acquired by the processing of Step 1301, and executes the processing of Steps 1307 to 1310 on the identifier of the selected communication apparatus 100 (communication apparatus U) (1306). The processing of Steps 1307 to 1310 is executed on the identifiers of all the communication apparatus 100 included in the communication apparatus list L.

The assertion control module 212 acquires an assertion table T of the communication apparatus U from the assertion DB 221 (1307). Specifically, as the assertion table T, the assertion control module 212 is configured to acquire the assertion entries in which the identifier of the communication apparatus U is registered in the Target Switch 602 of the assertion DB 221.

Next, the assertion control module 212 acquires from the flow table 223A included in the configuration DB 223 all the flow entries E relating to the assertion table T of the communication apparatus U acquired by the processing of Step 1307 (1308). Specifically, the assertion control module 212 is configured to acquire from the flow table 223A the flow entries identified by the identifier registered in the Flow Entry 601 of the assertion table T of the communication apparatus U. When there are a plurality of flow entries identified by the identifier registered in the Flow Entry 601 of the assertion table T of the communication apparatus U, all of those flow entries are acquired from the flow table 223A.

Next, the assertion control module 212 calculates a total value of the number of packets included in the statistical information registered in the Statistics 804 of a flow entry E acquired by the processing of Step 1308, decides the priority of the assertion entry in the assertion table T by scaling the calculated total value, and registers the decided priority in the Priority 607 of the assertion table T (1309). The control apparatus 200 includes a priority calculation table (not shown) in which the total value of the number of packets and the priority are associated with each other. The assertion control module 212 is configured to calculate the priority corresponding to the total value of the number of packets by referring to the priority calculation table. In the priority calculation table, the total value of the number of packets and the priority are associated with each other so that the priority is higher as the total value of the number of packets increases.

When the processing of Steps 1307 to 1309 has not been executed on the identifiers of all the communication apparatus 100 acquired by the processing of Step 1301, the assertion control module 212 returns the processing to Step 1306, and selects the identifier of a new communication apparatus 100. When the processing of Steps 1307 to 1309 has been executed on the identifiers of all the communication apparatus 100 acquired by the processing of Step 1301, the assertion control module 212 finishes the assertion DB priority update processing (1310).

In the assertion DB priority update processing, when the Priority 607 of the assertion DB 221 has been updated, the assertion control module 212 instructs each communication apparatus 100 to update the priority registered in the assertion memory 133 of that communication apparatus 100.

The assertion control module 212 may also register the statistical information on the communication apparatus U acquired by the processing of Step 1304 in the flow table 223A for each date, day of the week, time band, or the like of the statistical information, and may, in the processing of Step 1309, decide a priority for each date, day of the week, time band, or the like by calculating the total value of the number of packets for each date, day of the week, time band, or the like. The communication apparatus 100 traffic has a fixed pattern based on date, day of the week, time band, or the like, and hence the priority may be decided based on such a pattern.

As a result of the assertion DB priority update processing, the priority of an assertion is updated each predetermined time period based on the number of packets registered in the flow entry used to generate the assertion. Consequently, when there are more receptions of data matching the flow entry used to generate an assertion, the priority of that assertion may be increased, which enables the likelihood of that assertion of being registered in the assertion table 132 of the communication apparatus 100 to be increased. When there are more receptions of data matching the flow entry, the likelihood of a failure occurring increases, and the effects of the failure also increase. As a result of the assertion DB priority update processing, the assertion can be given a priority reflecting in real time the likelihood of a failure and the impact of the failure.

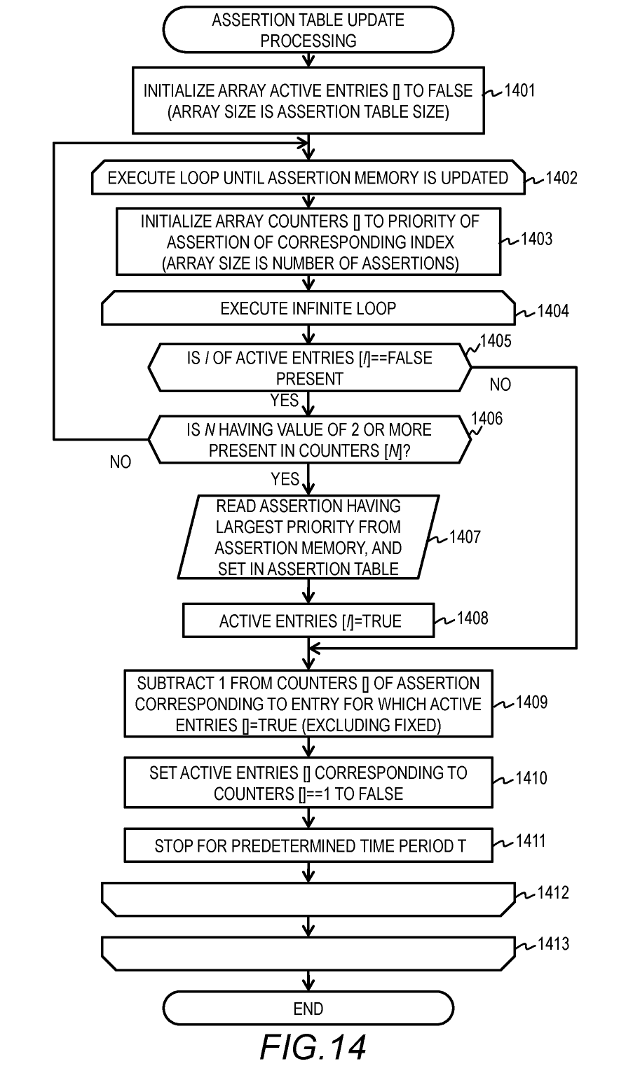

FIG. 14 is a flowchart of assertion table update processing according to the first embodiment.

The assertion table update processing is processing for registering an assertion entry registered in the assertion memory 133 of the communication apparatus 100 in the assertion table 132 based on the priority. The assertion table update processing is executed by the assertion control module 131 of the communication apparatus 100.

First, the assertion control module 131 initializes all the elements of the array Active Entries [ ] to False (1401). The array Active Entries [ ] correspond to each entry in the assertion table 132. When False is registered in the elements of the array Active Entries [ ], this means that the entries in the assertion table 132 corresponding to those elements are writable. When True is written in the array Active Entries [ ], this means that the entries in the assertion table 132 corresponding to those elements are unwritable.

Next, the assertion control module 131 repeatedly executes the processing of Steps 1403 to 1413 until the assertion memory 133 is updated (1402). The assertion memory 133 is updated based on an instruction from the control apparatus 200. When the assertion memory 133 has been updated, the assertion table update processing is executed again from the processing of Step 1401.

The assertion control module 131 initializes the array Counters [ ] by registering the priorities of the assertion entries registered in the assertion memory 133 in each element of the array Counters [ ] (1403).

Next, the assertion control module 131 executes the processing of Steps 1405 to 1412 in an infinite loop (1404).

First, the assertion control module 131 judges whether or not an i-th element in which False is registered in the array Active Entries [ ] is present (1405).

When it is judged in the processing of Step 1405 that an i-th element in which False is registered in the array Active Entries [ ] is not present (1405: No), that is, that all the entries in the assertion table 132 are unwritable, the assertion control module 131 advances the processing to Step 1409.

On the other hand, when it is judged in the processing of Step 1405 that an i-th element in which False is registered in the array Active Entries [ ] is present (1405: Yes), the assertion control module 131 judges whether or not an n-th element in which a value of 2 or more is registered is present in the array Counters [ ] (1406).

When it is judged by the processing of Step 1406 that an n-th element in which a value of 2 or more is registered is not present in the array Counters [ ] (1406: No), because this means that an assertion entry having a priority indicating that the assertion entry should be registered in the assertion table 132 is not present in the assertion memory 133, the assertion control module 131 returns the processing to Step 1402, and initializes the array Counters [ ] in the processing of Step 1403.

On the other hand, when it is judged by the processing of Step 1406 that an n-th element in which a value of 2 or more is registered is present in the array Counters [ ] (1406: Yes), the assertion control module 131 selects the assertion entries that are not registered in the assertion table 132 from among the assertion entries in the assertion memory 133, and registers the assertion entry having the largest priority registered in the array Counters [ ] among the selected assertion entries in the entry of the assertion table 132 corresponding to an i-th element in which False is registered in the array Active Entries [ ] (1407).

Next, the assertion control module 131 registers True in the i-th element of the array Active Entries [ ].

Next, the assertion control module 131 subtracts 1 from the values registered in the elements of the array Counters [ ] corresponding to the elements in which True is registered in the array Active Entries [ ] (1409). In the processing of Step 1409, the assertion control module 131 does not subtract 1 from the values registered in the elements of the array Counters [ ] in which Fixed is registered.

Next, the assertion control module 131 registers False in the elements of the array Active Entries [ ] corresponding to the elements in which, among the elements of the array Counters [ ], 1 is registered (1410).

Next, the assertion control module 131 stops the processing for a predetermined time period (time period T), and then advances the processing to Step 1412. The value of the time period T is arbitrarily set by the administrator or the like. Failure detection accuracy and power consumption of the communication apparatus 100 may be adjusted by setting the time period T in conjunction with the traffic characteristics of the network. When the time period T is set to be short, detection accuracy improves, but power consumption increases due to an increase in the number of read and write operations to the assertion table 132. On the other hand, when the time period T is set to be long, detection accuracy deteriorates, but power consumption decreases due to a reduction in the number of read and write operations to the assertion table 132. For example, in a situation in which a mixture of various types of traffic is present, it is desired that the time period T be set shorter. Further, in a situation in which the same type of traffic continues in bursts, it is desired that the time period T be set longer.

In the processing of Step 1412, when the repetitive processing of Steps 1405 to 1411 has finished, the assertion control module 131 advances the processing to Step 1413, and when the repetitive processing of Steps 1405 to 1411 has not finished, the assertion control module 131 returns the processing to Step 1404 (1412).

In the processing of Step 1413, when the repetitive processing of Steps 1403 to 1412 has finished, the assertion control module 131 finishes the assertion table update processing, and when the repetitive processing of Steps 1403 to 1412 has not finished, the assertion control module 131 returns the processing to Step 1402 (1413).

In the assertion table update processing, the processing of Steps 1705 to 1712 is performed each time period T. In the processing of Steps 1705 to 1712, the following processing is repeated each time period T. Specifically, the assertion entry having the largest priority is written in a writable entry of the assertion table 132, 1 is subtracted from the priorities of the assertion entries written in the assertion table 132, and entries in the assertion table 132 in which an assertion entry now having a priority of 1 is written are set as writable entries. As a result, an assertion entry having a priority of “3” is written in the assertion table 132 for only three time periods 3T. Thus, because the assertion entries registered in the assertion memory 133 are written by time sharing in the assertion table 132 based on priority, the write time to the assertion table 132 may be set longer for assertion entries having a higher priority, which enables a failure to be detected based on the priority of the assertion entry without increasing the capacity of the assertion table 132.

Usually, the assertion table 132 is stored in a TCAM 150 or the like that has a larger power consumption and a larger circuit scale than the memory 160, and hence there is a possibility that the assertion table 132 cannot store all of the assertion entries registered in the assertion memory 133. Therefore, it is important that failure detection accuracy can be maintained by performing assertion table update processing even without increasing the capacity of the assertion table 132.

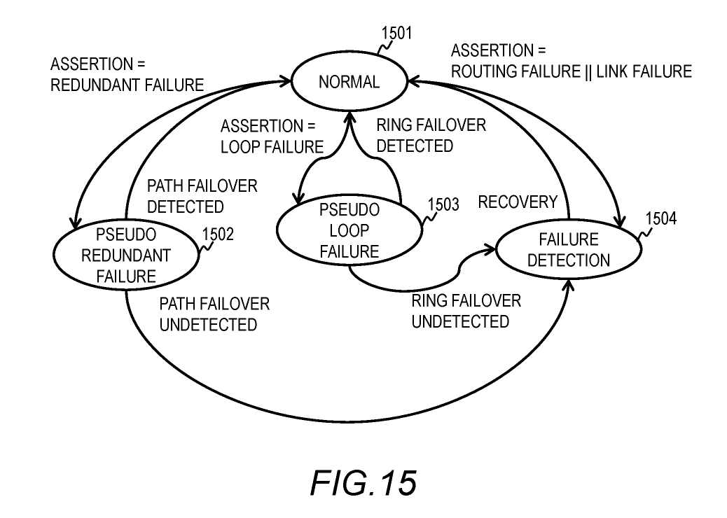

A failure detection operation based on the assertion table 132 in the communication apparatus 100 is now described with reference to FIG. 15 to FIG. 18.

FIG. 15 is a state transition diagram of the communication apparatus 100 according to the first embodiment.

Each communication apparatus 100 is capable of shifting to a Normal state 1501, a Pseudo Redundant Failure state 1502, a Pseudo Loop Failure state 1503, and a Failure Detection state 1504. The Normal state 1501 is a state in which the communication apparatus 100 is normal. The Pseudo Redundant Failure state 1502 is a state in which a redundant system failure is suspected. The Pseudo Loop Failure state 1503 is a state in which a loop failure is suspected. The Failure Detection state 1504 is a state in which a failure has been detected. The failures detected in FIG. 15 include a Routing Failure, a Link Failure, a Redundant Failure, and a Loop Failure.

The assertion control module 131 is configured to manage the state of the communication apparatus 100, and when a predetermined condition is satisfied, shift the state of the communication apparatus 100.

When the communication apparatus 100 is started, the state of the communication apparatus 100 is initialized to the Normal state 1501.

The assertion control module 131 is configured to shift, when a Redundant Failure is detected in the Normal state 1501 based on the assertion table 132, the state of the communication apparatus 100 to the Pseudo Redundant Failure state 1502.

The assertion control module 131 is configured to shift, when a Loop Failure is detected in the Normal state 1501 based on the assertion table 132, the state of the communication apparatus 100 to the Pseudo Loop Failure state 1503.

The assertion control module 131 is configured to shift, when a Routing Failure or Link Failure is detected in the Normal state 1501 based on the assertion table 132, the state of the communication apparatus 100 to the Failure Detection state 1504.

When the communication apparatus 100 receives, in the Pseudo Redundant Failure state 1502, a message from the control apparatus 200 that a Path Failover (Active path switch) has been detected, this means that a Redundant Failure has been detected due to the Active path having been switched. As a result, the assertion control module 131 shifts the state of the communication apparatus 100 to the Normal state 1501.

Further, when the communication apparatus 100 receives, in the Pseudo Redundant Failure state 1502, a message from the control apparatus 200 that a Path Failover (Active path switch) has not been detected, the assertion control module 131 shifts the state of the communication apparatus 100 to the Failure Detection state 1504.

When the communication apparatus 100 receives, in the Pseudo Loop Failure state 1503, a message from the control apparatus 200 that a Ring Failover (Ring switch) has been detected, this means that a Loop Failure has been detected due to the ring having been switched. As a result, the assertion control module 131 shifts the state of the communication apparatus 100 to the Normal state 1501.

Further, when the communication apparatus 100 receives, in the Pseudo Loop Failure state 1503, a message from the control apparatus 200 that a Ring Failover (Ring switch) has not been detected, the assertion control module 131 shifts the state of the communication apparatus 100 to the Failure Detection state 1504.

In the Failure Detection state 1504, when the detected failure has been recovered from, the assertion control module 131 shifts the state of the communication apparatus 100 to the Normal state 1501.

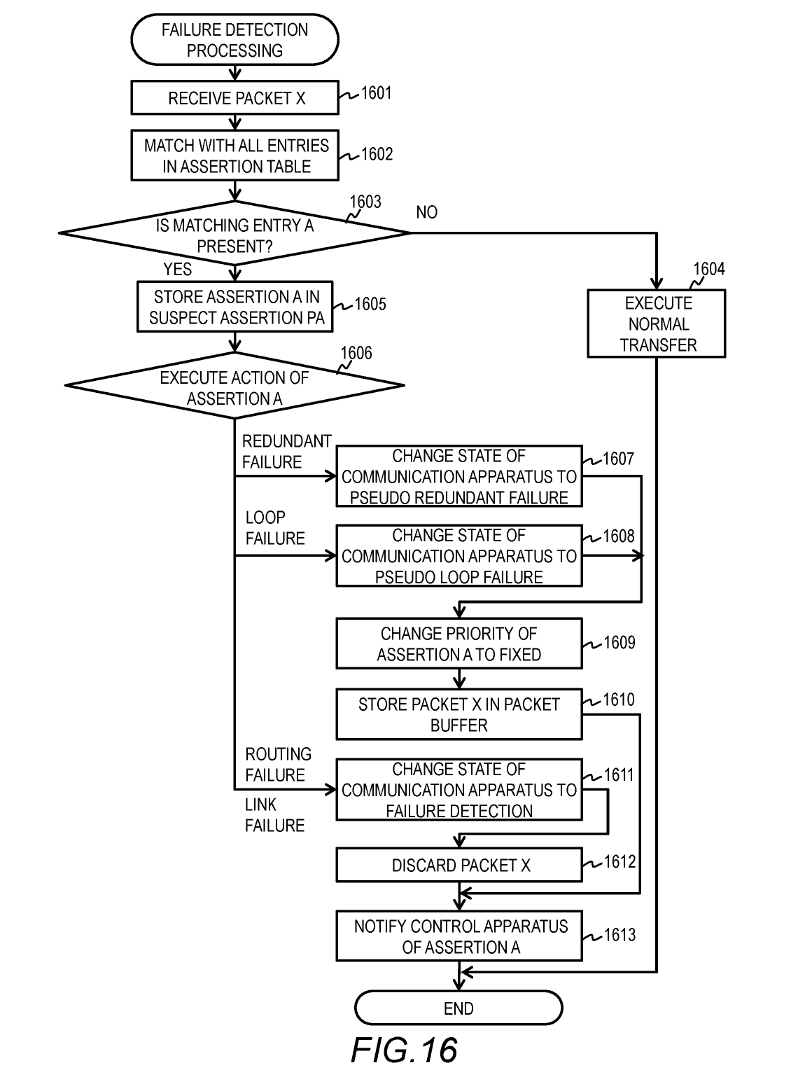

FIG. 16 is a flowchart of failure detection processing by the communication apparatus 100 according to the first embodiment.

The failure detection processing is processing for detecting various failure types by judging whether or not an assertion entry matching received data is present in the assertion table 132. The failure detection processing is executed by the assertion control module 131 when the communication apparatus 100 has received data.

First, the assertion control module 131 receives a packet X (1601), and checks whether or not the received packet X matches an assertion entry registered in the assertion table 132 (1602).

The assertion control module 131 judges whether or not an assertion entry matching the received packet X is present based on a check result of the processing of Step 1602 (1603).

When it is judged by the processing of Step 1603 that an assertion entry matching the received packet X is not present (1603: No), the assertion control module 131 judges that the received packet X is to be transferred normally (1604), executes normal transfer processing by the switch module 120, and then finishes the failure detection processing.

On the other hand, when it is judged by the processing of Step 1603 that an assertion entry matching the received packet X is present (1603: Yes), the assertion control module 131 stores the assertion entry matching the received packet X (assertion A) in the assertion control module 131 as a suspect assertion PA (1605).

Next, the assertion control module 131 divides the processing based on the failure type registered in the Action of assertion A (1606).

First, when the failure type registered in the Action of assertion A is Redundant Failure, the assertion control module 131 shifts the state of the communication apparatus 100 to the Pseudo Redundant Failure state 1502 (1607), and then advances the processing to Step 1609.

When the failure type registered in the Action of assertion A is Loop Failure, the assertion control module 131 shifts the state of the communication apparatus 100 to the Pseudo Loop Failure state 1503 (1608), and then advances the processing to Step 1609.

In the processing of Step 1609, the assertion control module 131 changes the priority of the assertion A to Fixed (1609). Through changing the priority of the assertion A to Fixed, assertion entries for which a failure is suspected are always in a written state in the assertion table 132, which enables the assertion control module 131 to judge each time a packet is received whether or not a failure has occurred in the applicable assertion.

Next, the assertion control module 131 stores the received packet X in the packet buffer 134 (1610), notifies the control apparatus 200 of the assertion A (1613), and finishes the failure detection processing.

Further, when the failure type registered in the Action of the assertion A is Routing Failure or Link Failure, the assertion control module 131 shifts the state of the communication apparatus 100 to the Failure Detection state 1504 (1611). Next, the assertion control module 131 discards the received packet X (1612), notifies the control apparatus 200 of the assertion A in the processing of Step 1613 (1613), and finishes the failure detection processing.

In the failure detection processing, in the case of a failure (Redundant Failure or Loop Failure) that relates to a redundant system network and that cannot be immediately determined as soon as the failure occurs, the received packet is stored in the packet buffer 134 until the failure is determined. As a result, packets that might be failures are prevented from being transferred. Further, in the case that those packets are not failures, the packets can be transferred, thereby preventing packet loss.

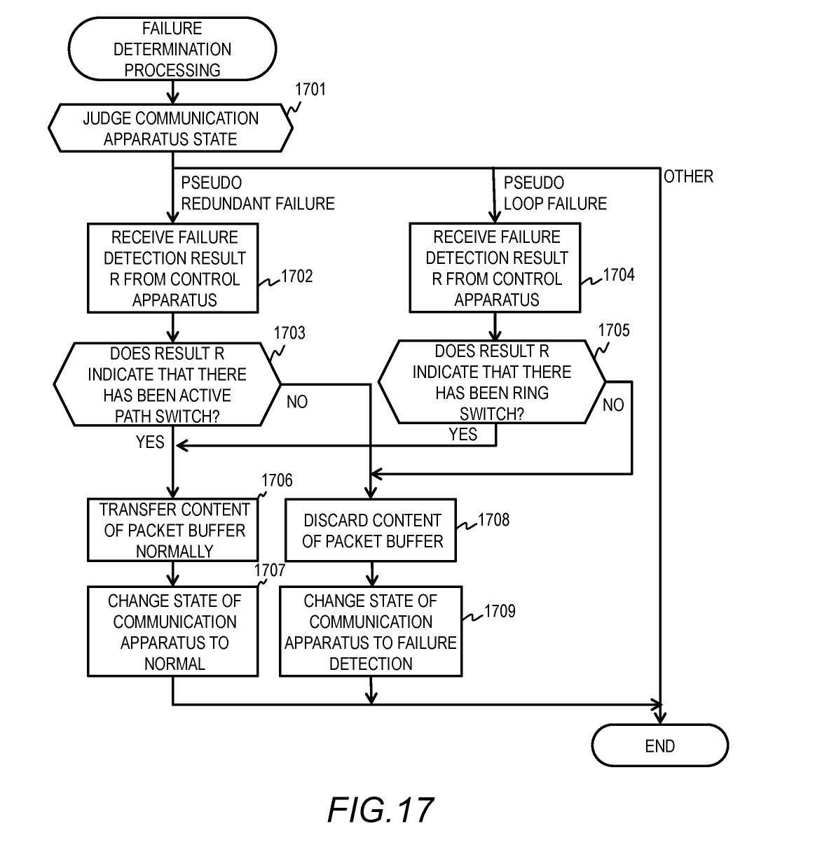

FIG. 17 is a flowchart of failure determination processing according to the first embodiment.

The failure determination processing is processing for determining, when a communication apparatus 100 is in the Pseudo Redundant Failure state 1502 or the Pseudo Loop Failure state 1503, whether or not a failure has occurred based on information from the control apparatus 200 indicating whether or not there has been a path switch. The failure determination processing is executed by the assertion control module 131.

First, the assertion control module 131 divides the processing based on the state of the communication apparatus 100 (1701).

When the communication apparatus 100 is in the Pseudo Redundant Failure state 1502, the communication apparatus 100 receives a failure detection result R from the control apparatus 200 (1702). The failure detection result R is a response to the assertion A notified to the control apparatus 200 by the processing of Step 1613 illustrated in FIG. 16 when the communication apparatus 100 has shifted to the Pseudo Redundant Failure state 1502 or the Pseudo Loop Failure state 1503. When the failure detection result R is a response to the assertion A of the Pseudo Redundant Failure state 1502, the failure detection result R includes information indicating whether or not there has been a switch in the Active path. When the failure detection result R is a response to the assertion A of the Pseudo Loop Failure state 1503, the failure detection result R includes information indicating whether or not there has been a ring switch.

Next, the assertion control module 131 judges whether or not the failure detection result R received by the processing of Step 1702 indicates that there has been an Active path switch (1703).

When it is judged by the processing of Step 1703 that the failure detection result R indicates that there has been an Active path switch (1703: Yes), the assertion control module 131 judges that the packet X stored in the packet buffer 134 is to be transferred normally (1706), and executes normal transfer processing by the switch module 120. Then, the assertion control module 131 shifts the state of the communication apparatus 100 to the Normal state 1501, and finishes the failure determination processing.

On the other hand, when it is judged by the processing of Step 1703 that the failure detection result R indicates that there has not been an Active path switch (1703: No), the assertion control module 131 discards the packet X stored in the packet buffer 134 (1708), shifts the state of the communication apparatus 100 to the Failure Detection state 1504 (1709), and finishes the failure determination processing.

When the communication apparatus 100 is in the Pseudo Loop Failure state 1503, the communication apparatus 100 receives the failure detection result R from the control apparatus 200 (1704). The assertion control module 131 then judges whether or not the failure detection result R received by the processing of Step 1704 indicates that there has been a ring switch (1705).

When it is judged by the processing of Step 1705 that the failure detection result R indicates that there has been a ring switch (1705: Yes), in the processing of Step 1706, the assertion control module 131 transfers the packet X stored in the packet buffer 134 in a normal manner. Then, in the processing of Step 1707, the assertion control module 131 shifts the state of the communication apparatus 100 to the Normal state 1501, and finishes the failure determination processing.

On the other hand, when it is judged by the processing of Step 1705 that the failure detection result R indicates that there has not been a ring switch (1705: No), in the processing of Step 1708, the assertion control module 131 discards the packet X stored in the packet buffer 134. Then, in the processing of Step 1709, the assertion control module 131 shifts the state of the communication apparatus 100 to the Failure Detection state 1504, and finishes the failure determination processing.

When the communication apparatus 100 is in a state other than the Pseudo Redundant Failure state 1502 or the Pseudo Loop Failure state 1503, the assertion control module 131 finishes the failure determination processing.

Therefore, according to this embodiment, the communication apparatus 100 are capable of detecting that data different from normal operation has been received, and determining a failure in consideration of whether there has been a path switch or a ring switch, by matching the received data with the assertion entries registered in the assertion table 132.

In the technology disclosed in JP 2013-46090 A, failures are detected based on a CCM. However, even if a failure has not occurred in the CCM, a failure may have occurred in another packet, such as, for example, when a failure has occurred in a specific circuit due to a software error caused by cosmic radiation and the like. In the technology for detecting failures based on a CCM, there is a problem in that this kind of failure cannot be detected.

In order to detect this kind of failure, whether or not a failure has occurred in any of the entries set in the communication apparatus 100 may be verified. In this case, the number of test packets equal to the number of flow entries is required, which causes a problem in that the load on the communication apparatus 100 is increased, and network bandwidth is consumed by the test packets.

Further, when detecting a failure based on a CCM, the failure cannot be correctly detected unless the settings for transmission and reception of the CCM are appropriate. For example, when it is desired to detect a failure to an accuracy of 300 milliseconds or less, there is a problem in that the failure cannot be detected to the desired accuracy when the CCM transmission timing is set at 1 second intervals.

According to this embodiment, through registering the conditions for detecting a failure in the assertion table 132, and referring to the assertion table 132, a failure that occurs in another packet may be detected even when a failure has not occurred in a test packet, such as a CCM. Further, setting mistakes in the communication apparatus 100 can be detected and the reliability of the network can be improved by the administrator registering a failsafe assertion entry or a debugging assertion entry in advance in the assertion table 132.

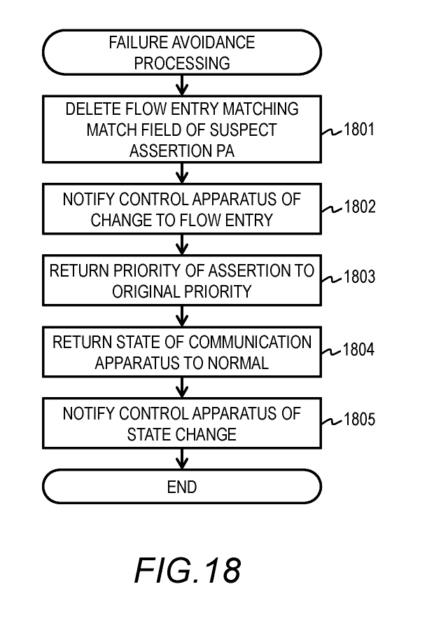

FIG. 18 is a flowchart of failure avoidance processing according to the first embodiment.

The failure avoidance processing is processing for avoiding, when a failure has been determined, the failure by deleting from the flow table 123 the flow entry corresponding to the assertion entry that is the source of the failure. The failure avoidance processing is executed by the flow table control module 121 and the assertion control module 131.

First, the flow table control module 121 deletes from the flow table 123 a flow entry in which the information registered in the Match Field 301 of the flow table 123 matches the information registered in the Match Field of the suspect assertion PA stored by the processing of Step 1605 illustrated in FIG. 16 (1801). As a result, failures may be avoided in flow units by deleting from the flow table 123 flow entries in which a failure has occurred.

Next, the flow table control module 121 notifies the control apparatus 200 of the flow entry deleted by the processing of Step 1801 (1802). The control apparatus 200 deletes, when the control apparatus 200 receives the notification of the deletion of the flow entry, that flow entry from the flow table 223A of the configuration DB 223.

Next, when the priority of the assertion A has been changed by the processing of Step 1609 to Fixed, the assertion control module 131 changes the priority of the assertion A to the original priority (1803).

Next, the assertion control module 131 shifts the state of the communication apparatus 100 to the Normal state 1501 (1804).

Next, the assertion control module 131 notifies the control apparatus 200 of the fact that the state of the communication apparatus 100 has been shifted to the Normal state 1501 (1805), and then finishes the failure avoidance processing.

With the failure avoidance processing, when a failure has been determined, the failure can be avoided in flow entry units by deleting from the flow table 123 the flow entries in which the failure occurred.

For example, in the ERP disclosed in JP 2013-46090 A, a continuity failure is detected in ring units, and the continuity failure cannot be detected in flow units. In JP 2013-46090 A, because the failure is detected in ring units, there is a problem in that all of the plurality of flows belonging to the ring in which the failure has been detected are affected. Further, when a failure occurs in the ring and there is a ring switch, the content of the FDB of the communication apparatus 100 is deleted. As a result, the communication apparatus 100 needs to relearn the content of the FDB, causing the processing load to increase. In addition, because the communication apparatus 100 are flooded with received packets during the FDB learning period, pressure is placed on network bandwidth.

In this embodiment, a failure is avoided in flow entry units based on failure avoidance processing, and the ring is not switched. Therefore, the impact of the failure avoidance can be minimized, allowing an increase in the processing load on the communication apparatus 100 due to the learning of the content of the FDB and pressure on network bandwidth to be avoided.

Next, failure identification processing executed by the control apparatus 200, which has been notified that the communication apparatus 100 has detected a failure, is described with reference to FIG. 19 to FIG. 25.

FIG. 19 is a flowchart of the failure identification processing according to the first embodiment.

The failure identification processing is processing for identifying a failure cause and the like based on the failure type detected by the communication apparatus 100. The failure identification processing is executed by the failure identification module 214 of the control apparatus 200 when the control apparatus 200 is notified of an assertion A in which a failure has been detected from a communication apparatus 100.

First, the failure identification module 214 receives the assertion A from the communication apparatus X that detected the failure (1901). The communication apparatus 100 X transmits the assertion A to the control apparatus 200 by the processing of Step 1613 illustrated in FIG. 16.

Next, the failure identification module 214 extracts the input port P from the Match Field of the received assertion A (1902).

Next, the failure identification module 214 refers to the topology table 224B of the topology DB 224, and retrieves the communication apparatus U coupled to the port P of the communication apparatus X (1903).

Next, the failure identification module 214 divides the processing based on the failure type registered in the Action of the assertion A (1904).

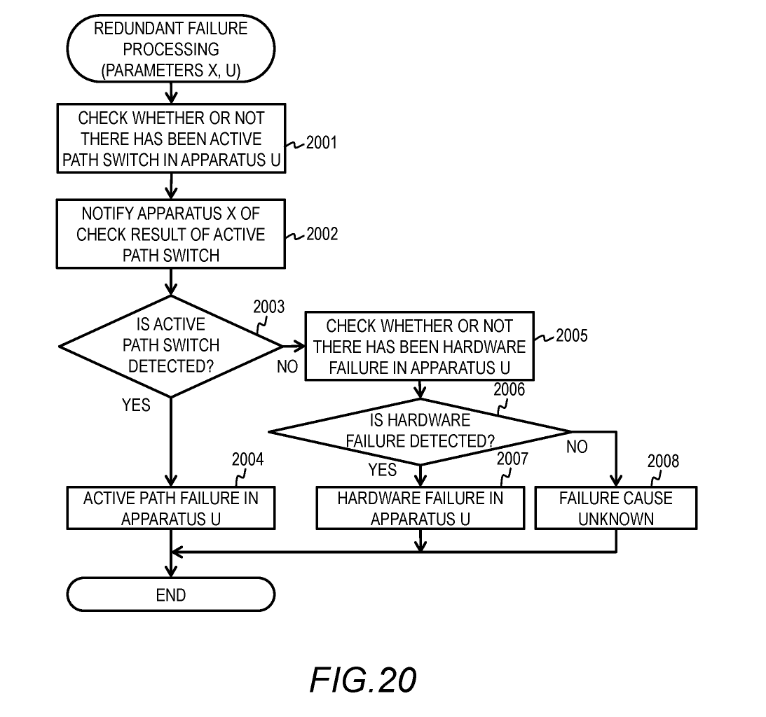

When Redundant Failure is registered in the Action of the assertion A, the failure identification module 214 calls redundant failure processing using the identifier of the communication apparatus X and the identifier of the communication apparatus U as parameters, executes the redundant failure processing (1905), and then finishes the failure identification processing. The redundant failure processing is described in more detail with reference to FIG. 20.

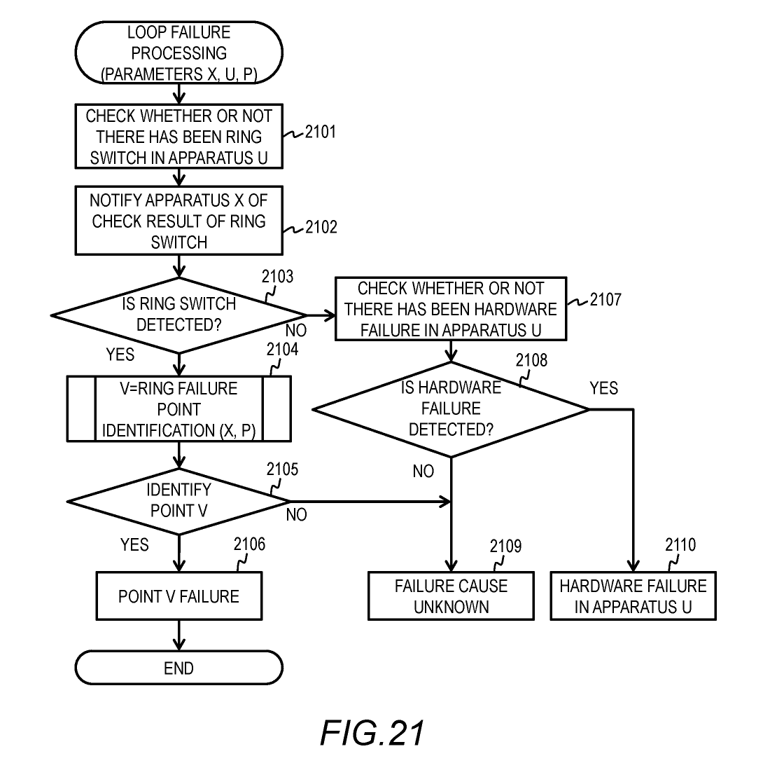

When Loop Failure is registered in the Action of the assertion A, the failure identification module 214 calls loop failure processing using the identifier of the communication apparatus X and the identifier of the communication apparatus U and the identifier of the port P as parameters, executes the loop failure processing (1906), and then finishes the failure identification processing. The loop failure processing is described in more detail with reference to FIG. 21.

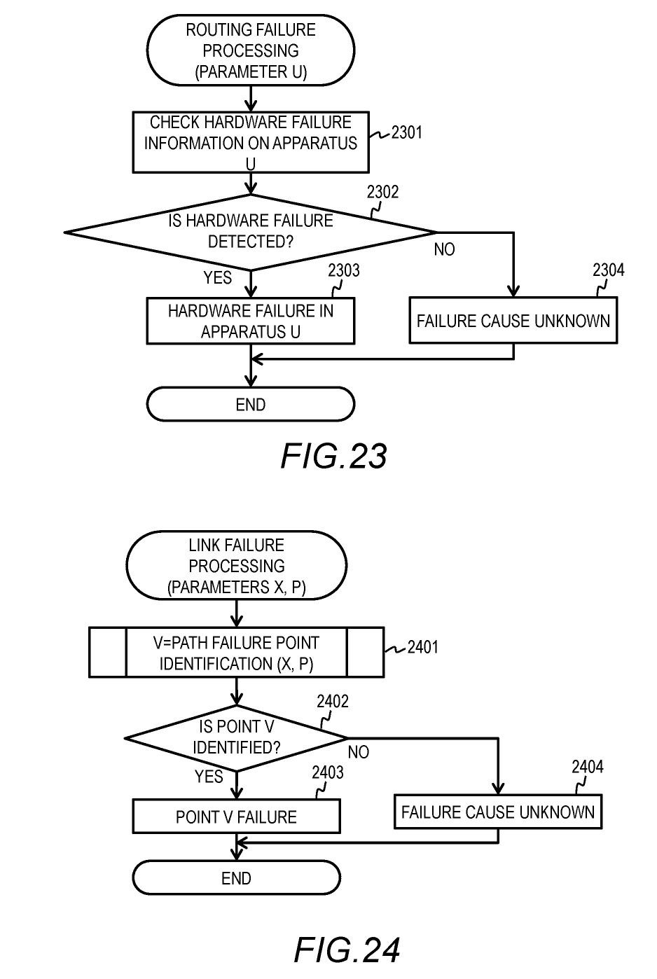

When Routing Failure is registered in the Action of the assertion A, the failure identification module 214 calls routing failure processing using the identifier of the communication apparatus U as a parameter, executes the routing failure processing (1907), and then finishes the failure identification processing. The routing failure processing is described in more detail with reference to FIG. 23.

When Link Failure is registered in the Action of the assertion A, the failure identification module 214 calls link failure processing using the identifier of the communication apparatus X and the identifier of the port P as parameters, executes the link failure processing (1908), and then finishes the failure identification processing. The link failure processing is described in more detail with reference to FIG. 24.

FIG. 20 is a flowchart of the redundant failure processing according to the first embodiment.

The redundant failure processing is processing for identifying the failure cause when a Redundant Failure has been detected by the communication apparatus 100. The redundant failure processing is executed by the failure identification module 214.

The failure identification module 214 checks whether or not there has been a switch in the Active path in the communication apparatus U (2001). For example, the redundant path may be constructed by using a link aggregation group (LAG) and the like. Further, for example, the failure identification module 214 may acquire the address of the communication apparatus U by referring to the communication apparatus management table 224A of the topology DB 224, access the communication apparatus U via the management I/F 230, and check whether or not there has been a switch in the Active path in the communication apparatus U.

The failure identification module 214 notifies the communication apparatus X of the check result of the processing of Step 2001 as the failure detection result R (2002).

Next, the failure identification module 214 refers to the check result of the processing of Step 2001, and decides whether or not there has been an Active path switch in the communication apparatus U (2003).

When it is judged by the processing of Step 2003 that there has been an Active path switch in the communication apparatus U (2003: Yes), because this means the Active path was switched due to the occurrence of a failure in the Active path of the communication apparatus U, the failure identification module 214 decides that the cause of the Redundant Failure is the occurrence of a failure in the Active path of the communication apparatus U (2004), and finishes the redundant failure processing.

On the other hand, when it is judged by the processing of Step 2003 that there has not been an Active path switch in the communication apparatus U (2003: No), the failure identification module 214 checks whether or not there has been a hardware failure in the communication apparatus U (2005). As the method of checking whether or not there has been a hardware failure in the communication apparatus U by the failure identification module 214, the same method as the processing of Step 2001 may be employed.

Next, the failure identification module 214 refers to the check result of the processing of Step 2005, and judges whether or not there has been a hardware failure in the communication apparatus U (2006).

When it is judged by the processing of Step 2006 that there has been a hardware failure in the communication apparatus U (2006: Yes), the failure identification module 214 judges that the cause of the Redundant Failure is the occurrence of a hardware failure in the communication apparatus U (2007), and finishes the redundant failure processing.

On the other hand, when it is judged by the processing of Step 2006 that there has not been a hardware failure in the communication apparatus U (2006: No), the failure identification module 214 judges that the cause of the Redundant Failure is unknown (2008), and finishes the redundant failure processing.

FIG. 21 is a flowchart of the loop failure processing according to the first embodiment.

The loop failure processing is processing for identifying the failure cause when a Loop Failure has been detected by the communication apparatus 100. The loop failure processing is executed by the failure identification module 214.

First, the failure identification module 214 judges whether or not there has been a ring switch in the communication apparatus U (2101). As the method of checking whether or not there has been a ring switch in the communication apparatus U by the failure identification module 214, the same method as the processing of Step 2001 may be employed.

Next, the failure identification module 214 notifies the communication apparatus X of the check result of the processing of Step 2101 as the failure detection result R (2102).

Next, the failure identification module 214 refers to the check result of the processing of Step 2101, and judges whether or not there has been a ring switch in the communication apparatus U (2103).

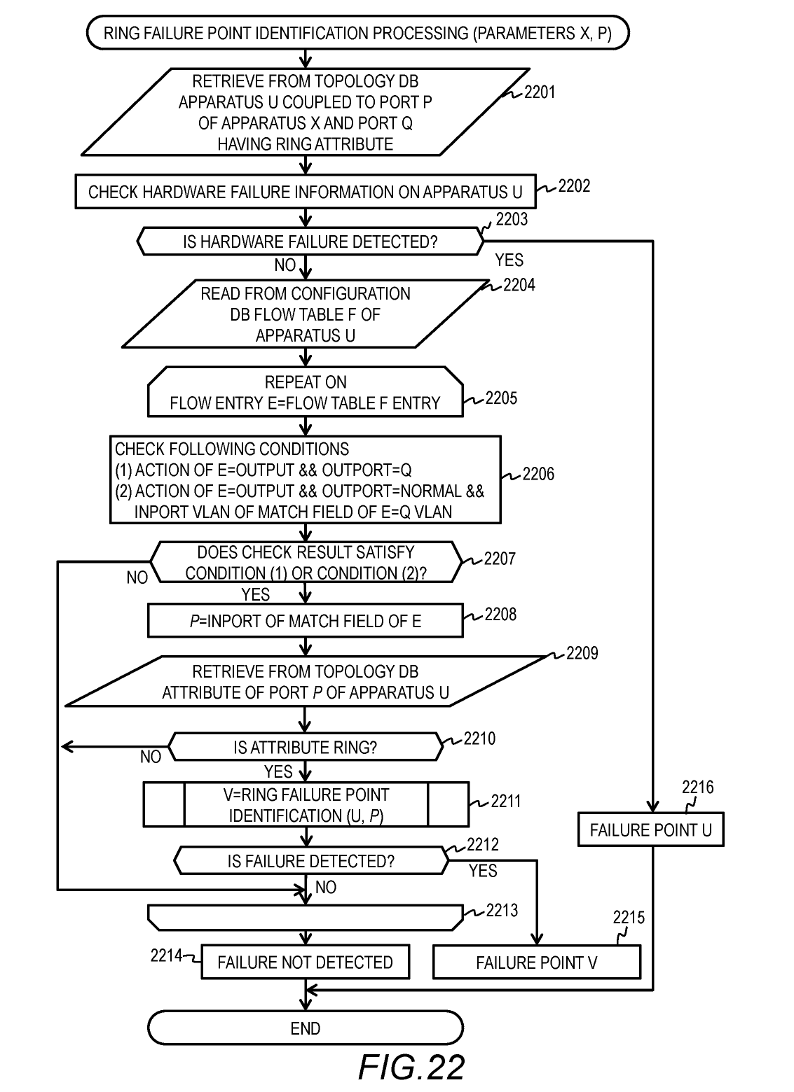

When it is judged by the processing of Step 2103 that there has been a ring switch in the communication apparatus U (2103: Yes), the failure identification module 214 calls ring failure point identification processing using the identifier of the communication apparatus X and the identifier of the port P as parameters, and executes ring failure point identification processing (2104). The ring failure point identification processing is described in more detail with reference to FIG. 22.

Next, the failure identification module 214 judges whether or not a failure point V has been identified by the ring failure point identification processing (2105).

When it is judged by the processing of Step 2105 that a failure point V has been identified by the ring failure point identification processing (2105: Yes), the failure identification module 214 judges that the cause of the Loop Failure is the occurrence of a failure at the failure point V (2106), and finishes the loop failure processing.

On the other hand, when it is judged by the processing of Step 2105 that a failure point V has not been identified by the ring failure point identification processing (2105: No), the failure identification module 214 judges that the cause of the Loop Failure is unknown (2109), and finishes the loop failure processing.

On the other hand, when it is judged by the processing of Step 2103 that there has not been a ring switch in the communication apparatus U (2103: No), the failure identification module 214 checks whether or not there has been a hardware failure in the communication apparatus U (2107). As the method of checking whether or not there has been a hardware failure in the communication apparatus U by the failure identification module 214, the same method as the processing of Step 2001 may be employed.

Next, the failure identification module 214 refers to the check result of the processing of Step 2107, and judges whether or not there has been a hardware failure in the communication apparatus U (2108).

When it is judged by the processing of Step 2108 that there has not been a hardware failure in the communication apparatus U, the failure identification module 214 judges that the cause of the Loop Failure is unknown in the processing of Step 2109, and finishes the loop failure processing.

When it is judged by the processing of Step 2108 that there has been a hardware failure in the communication apparatus U, the failure identification module 214 judges that the cause of the Loop Failure is a hardware failure in the communication apparatus U (2110), and finishes the loop failure processing.

FIG. 22 is a flowchart of the ring failure point identification processing according to the first embodiment.

The ring failure point identification processing is processing for judging whether or not the failure is occurring in an upstream-side communication apparatus coupled to the port P of the communication apparatus X by a ring topology. The ring failure point identification processing is executed by the failure identification module 214.

First, the failure identification module 214 refers to the topology table 224B of the topology DB 224, and retrieves the identifier of the port Q of the communication apparatus U coupled to the port P of the communication apparatus X by a ring topology and the identifier of the communication apparatus U (2201).

Next, the failure identification module 214 checks whether or not there has been a hardware failure in the communication apparatus U (2202). As the method of checking whether or not there has been a hardware failure in the communication apparatus U by the failure identification module 214, the same method as the processing of Step 2001 may be employed.

Next, the failure identification module 214 refers to the check result of the processing of Step 2202, and judges whether or not there has been a hardware failure in the communication apparatus U (2203).

When it is judged by the processing of Step 2303 that there has been a hardware failure in the communication apparatus U (2303: Yes), the failure identification module 214 identifies the failure point V in the communication apparatus U (2216), and finishes the ring failure point identification processing.

On the other hand, when it is judged by the processing of Step 2303 that there has not been a hardware failure in the communication apparatus U (2303: No), the failure identification module 214 refers to the flow table 223A of the configuration DB 223, and acquires the flow table F of the communication apparatus U (2204).

Next, the failure identification module 214 selects a flow entry E in the flow table F of the communication apparatus U acquired by the processing of Step 2204, and executes the processing of Steps 2206 to 2213 on the selected flow entry E (2205). The processing of Steps 2206 to 2213 is executed on all the flow entries in the flow table F.

The failure identification module 214 checks whether or not the flow entry E satisfies a condition (1) or a condition (2) (2206). The condition (1) is that Output is registered in the Action of the flow entry E, and that the Outport registered in the Action of the flow entry E is the port Q. More specifically, the condition (1) is that the output port of the flow entry E of the communication apparatus U is the port Q of the communication apparatus U coupled to the port P of the communication apparatus X by a ring topology.

The condition (2) is that Output is registered in the Action of the flow entry E, that the Outport registered in the Action of the flow entry E is Normal, and that the VLAN registered in the Match Field of the flow entry E is the same as the VLAN of the port Q. More specifically, the condition (2) is that the data output from the output port of the flow entry E of the communication apparatus U is input to the port P of the communication apparatus X.

Next, the failure identification module 214 refers to the check result of the processing of Step 2206, and judges whether or not the flow entry E satisfies the condition (1) or the condition (2) (2207).

When it is judged by the processing of Step 2207 that the flow entry E satisfies the condition (1) or the condition (2) (2207: Yes), the failure identification module 214 sets the input port of the Match Field of the flow entry E to a port p (2208).

Next, the failure identification module 214 refers to the topology table 224B of the topology DB 224, and retrieves an attribute of the port p of the communication apparatus U (2209). Then, the failure identification module 214 judges whether or not the attribute of the port p of the communication apparatus U retrieved by the processing of Step 2209 is ring topology (2210).

When it is judged by the processing of Step 2210 that the attribute of the port p of the communication apparatus U is ring topology (2210: Yes), the failure identification module 214 recursively executes the ring failure point identification processing using the identifier of the communication apparatus U and the identifier of the port p as parameters (2211).

Next, the failure identification module 214 judges whether or not a failure has been detected by the ring failure point identification processing executed by the processing of Step 2211 (2212).

When it is judged by the processing of Step 2212 that a failure has been detected by the ring failure point identification processing (2212: Yes), the failure identification module 214 identifies as the failure point V the communication apparatus V in which the failure was detected (2215), and then finishes the ring failure point identification processing.

On the other hand, when it is judged by the processing of Step 2212 that a failure has not been detected by the ring failure point identification processing (2212: No), and when the processing of Steps 2206 to 2213 has not been executed on all the flow entries E in the flow table F, the failure identification module 214 returns the processing to Step 2205, and selects a new flow entry E from the flow entries in the flow table F. On the other hand, when the processing of Steps 2206 to 2213 has been executed on all the flow entries E in the flow table F, the failure identification module 214 judges that a failure has not been detected (2214), and finishes the ring failure point identification processing.

When it is judged by the processing of Step 2207 that the flow entry E does not satisfy the condition (1) or the condition (2) (2207: No), or when it is judged by the processing of Step 2210 that the attribute of the port p of the communication apparatus U is not ring topology (2210: No), the failure identification module 214 advances the processing to Step 2214.

FIG. 23 is a flowchart of routing failure processing according to the first embodiment.

The routing failure processing is processing for identifying the failure cause when the communication apparatus 100 has detected a Routing Failure. The routing failure processing is executed by the failure identification module 214.

First, the failure identification module 214 checks whether or not there has been a hardware failure in the communication apparatus U (2301). As the method of checking whether or not there has been a hardware failure in the communication apparatus U by the failure identification module 214, the same method as the processing of Step 2001 may be employed.

Next, the failure identification module 214 refers to the check result of the processing of Step 2301, and judges whether or not there has been a hardware failure in the communication apparatus U (2302).

When it is judged by the processing of Step 2302 that there has been a hardware failure in the communication apparatus U (2302: Yes), the failure identification module 214 judges that the cause of the Routing Failure is a hardware failure in the communication apparatus U (2303), and finishes the routing failure processing.

When it is judged by the processing of Step 2302 that there has not been a hardware failure in the communication apparatus U (2302: No), the failure identification module 214 judges that the cause of the Routing Failure is unknown (2304), and finishes the routing failure processing.

FIG. 24 is a flowchart of link failure processing according to the first embodiment.

The link failure processing is processing for identifying the failure cause when the communication apparatus 100 has detected a Link Failure. The link failure processing is executed by the failure identification module 214.

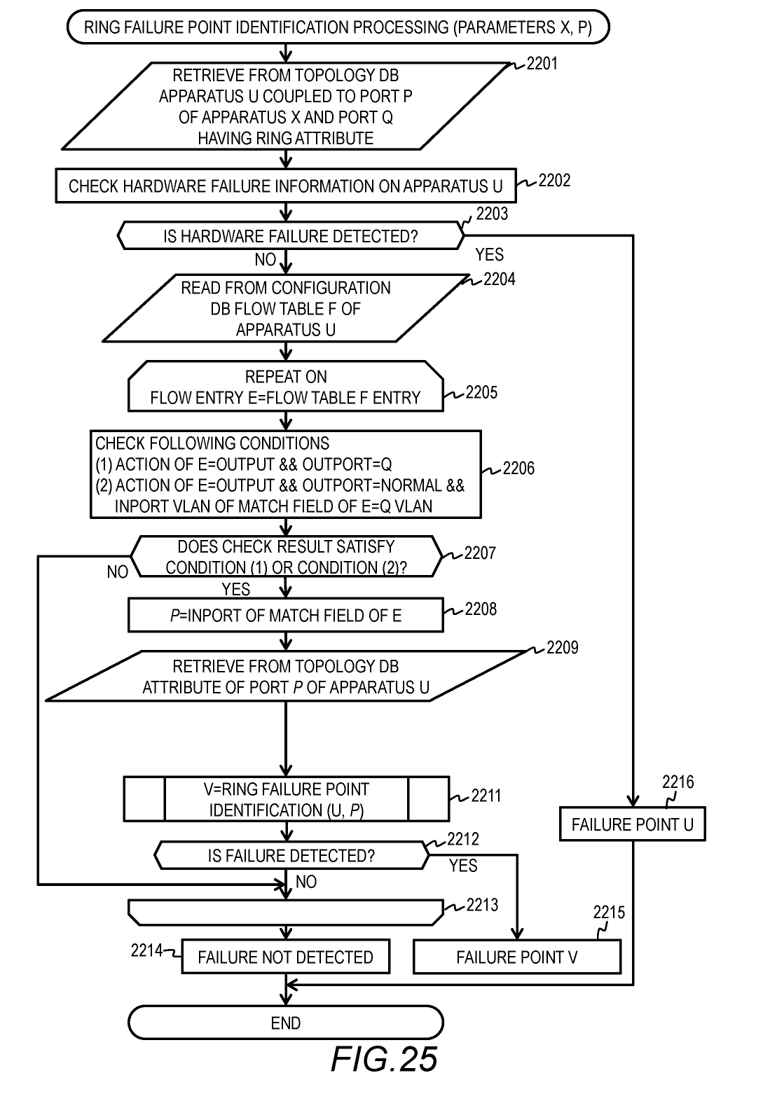

First, the failure identification module 214 calls path failure point identification processing using the identifier of the communication apparatus X and the identifier of the port P as parameters, and executes the path failure point identification processing (2401). The path failure point identification processing is described in more detail with reference to FIG. 25.

Next, the failure identification module 214 judges whether or not a failure point V has been identified by the path failure point identification processing (2402).

When it is judged by the processing of Step 2402 that a failure point V has been identified by the path failure point identification processing (2402: Yes), the failure identification module 214 judges that the cause of the Link Failure is the occurrence of a failure at the failure point V (2403), and finishes the link failure processing.

On the other hand, when it is judged by the processing of Step 2402 that a failure point V has not been identified by the path failure point identification processing (2402: No), the failure identification module 214 judges that the cause of the Link Failure is unknown (2404), and finishes the link failure processing.

FIG. 25 is a flowchart of path failure point identification processing according to the first embodiment.

The path failure point identification processing is processing for judging whether or not a failure is occurring in an upstream-side communication apparatus coupled to the port P of the communication apparatus X. The path failure point identification processing is executed by the failure identification module 214. Processes illustrated in FIG. 25 that are the same as the ring failure point identification processing illustrated in FIG. 22 are denoted using like reference numerals, and a description thereof is omitted here.

The path failure point identification processing differs from the ring failure point identification processing in that the path failure point identification processing does not execute processing for judging whether or not an attribute of the input port of the Match Field of the flow entry of the communication apparatus U is ring topology (processing of Step 2210 illustrated in FIG. 22).

According to this embodiment, the position of a failure can be identified by the control apparatus 200 based on the failure detected by the communication apparatus 100. In the technology disclosed in JP 2013-46090 A, an identification method based on ring topology is disclosed, and hence the position of a failure for other topologies cannot be identified. When the position of a failure can be identified, the administrator or the like can perform a failure recovery operation at an early stage by referring to the identification result, which enables an improvement in network reliability.

### Second Embodiment

In the first embodiment, the control apparatus 200 is configured to generate an assertion entry of the communication apparatus 100 by executing the assertion table generation processing illustrated in FIG. 10, and update the priority of the assertion entry by executing the assertion DB priority update processing illustrated in FIG. 13. However, in a second embodiment of this invention, the communication apparatus 100 are configured to generate an assertion entry, and update the priority of the assertion entry. As a result, the processing load on the control apparatus 200 is distributed among the communication apparatus 100.

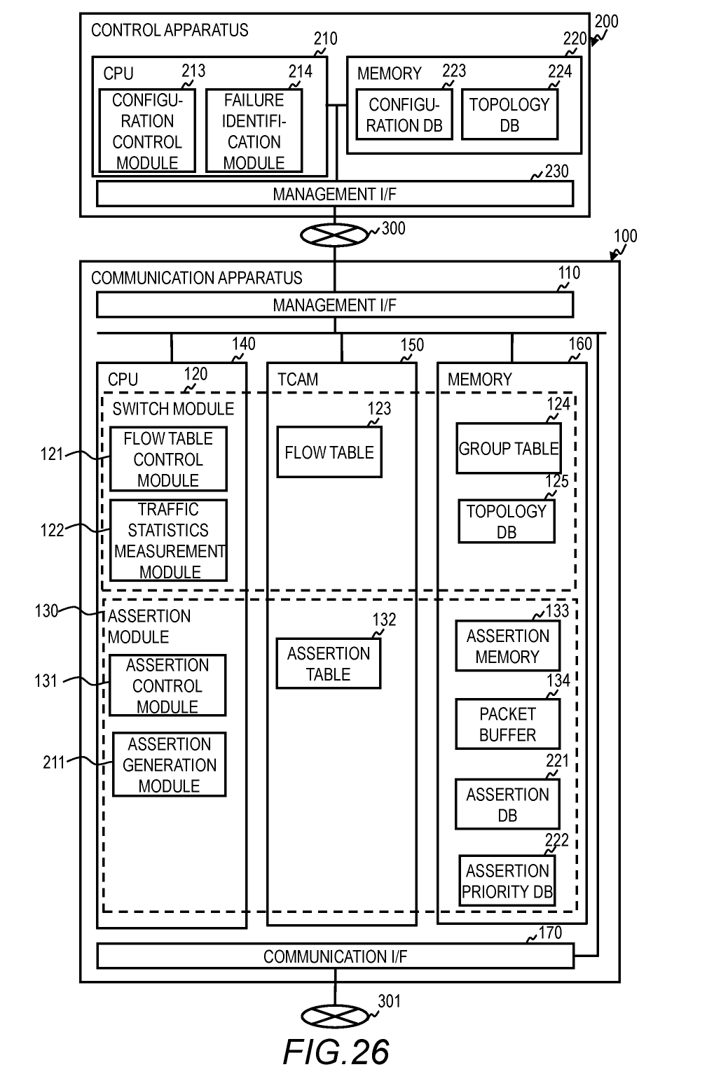

This embodiment is described with reference to FIG. 26 to FIG. 28.

FIG. 26 is a block diagram for illustrating a configuration of a communication system according to the second embodiment. In FIG. 26, the parts that are the same as in FIG. 1 are denoted using like reference numerals, and a description thereof is omitted here.

The switch module 120 of the communication apparatus 100 according to this embodiment includes, in addition to the parts according to the first embodiment, a topology DB 125. The topology DB 125 is stored in the memory 160. Further, the assertion module 130 of the communication apparatus 100 according to this embodiment includes, in addition to the parts according to the first embodiment, the assertion generation module 211, the assertion DB 221, and the assertion priority DB 222. The assertion generation module 211 is mounted in the CPU 140. The assertion DB 221 and the assertion priority DB 222 are stored in the memory 160.

Further, the control apparatus 200 according to this embodiment differs from the control apparatus 200 according to the first embodiment in terms of not including the assertion generation module 211, the assertion control module 212, the assertion DB 221, and the assertion priority DB 222.

The assertion generation module 211 according to the first embodiment is configured to generate all the assertion entries having a possibility of being registered in the assertion table 132 of the communication apparatus 100. However, the assertion generation module 211 according to this embodiment is configured to generate a portion of the assertion entries having a possibility of being registered in the assertion table 132 of an adjacent communication apparatus 100.

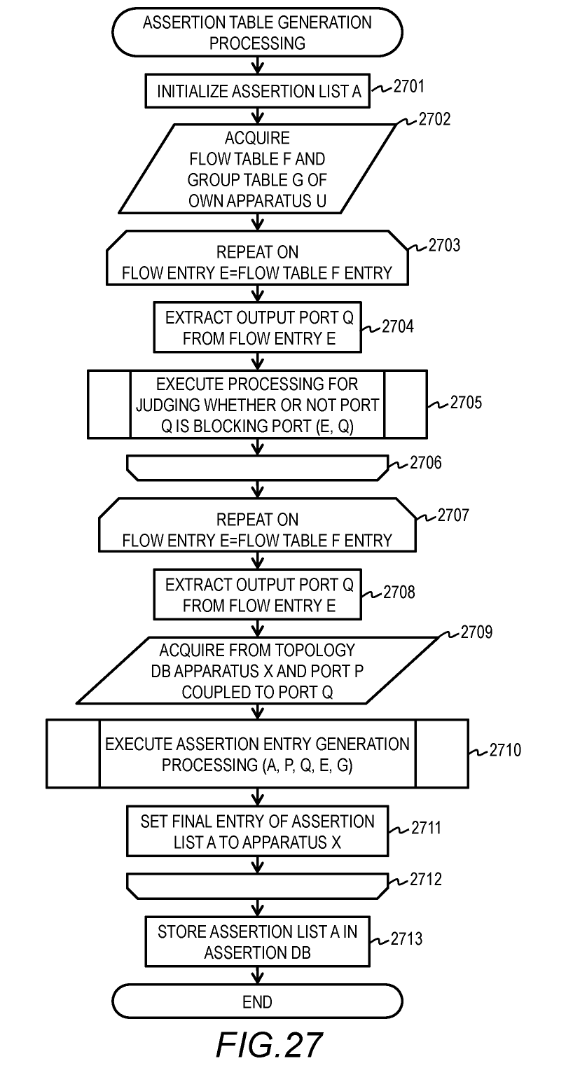

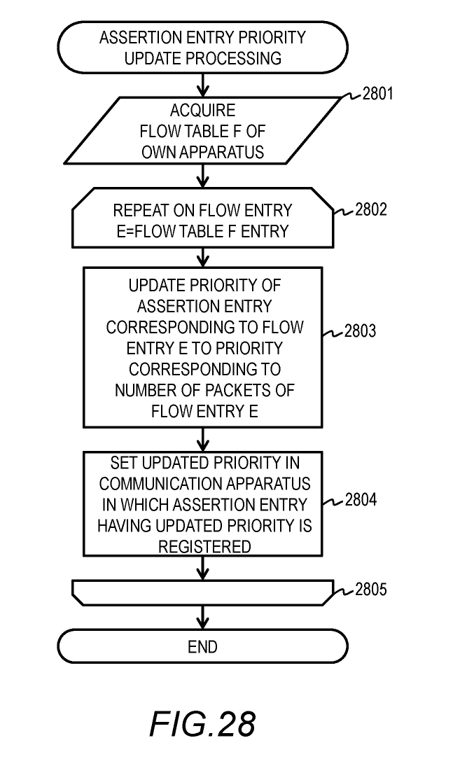

Further, the assertion control module 131 according to this embodiment also has a function of the assertion control module 212 of the control apparatus 200 according to the first embodiment. Specifically, the assertion control module 131 is configured to instruct, when an assertion entry of an adjacent communication apparatus 100 has been generated by assertion table generation processing illustrated in FIG. 27, the adjacent communication apparatus 100 via the management I/F 110 to register the generated assertion entry. In addition, the assertion control module 131 is configured to instruct, when an assertion entry of an adjacent communication apparatus 100 has been updated by assertion entry priority update processing illustrated in FIG. 28, the adjacent communication apparatus 100 via the management I/F 110 to update the priority of the assertion entry.

The topology DB 125 of the communication apparatus 100 has the same content as the topology DB 224 of the control apparatus 200. The configuration control module 213 of the control apparatus 200 is configured to issue an instruction to the communication apparatus 100 via the management I/F 230 to replicate the content of the topology DB 224.

FIG. 27 is a flowchart of assertion table generation processing according to the second embodiment.

The assertion table generation processing is processing for generating a portion of the assertion entries having a possibility of being registered in the assertion table 132 of an adjacent communication apparatus 100. The assertion table generation processing is executed by the assertion generation module 211 of the communication apparatus 100.

First, the assertion generation module 211 initializes an assertion list (variable A) for storing the generated assertion entries (2701).

Next, the assertion generation module 211 acquires as the flow table F and the group table G, respectively, the flow table 123 and the group table 124 of the communication apparatus U that includes the assertion generation module 211 itself (2702).

The assertion generation module 211 selects a processing target flow entry E from the flow table F acquired by the processing of Step 2702, and executes the processing of Steps 2704 to 2706 (2703). The processing of Steps 2704 to 2706 is repeated until the processing has been executed on all the flow entries of the flow table F.

The assertion generation module 211 extracts the output port Q registered in the Action of the flow entry E selected by the processing of Step 2703 (2704). For example, when the output port of the Action of the flow entry E is Normal, the assertion generation module 211 refers to the FDB and identifies the output port Q.

Next, the assertion generation module 211 executes blocking port judgement processing for judging whether or not the output port Q is a blocking port (2705). In the blocking port judgement processing, the identifier of the flow entry E and the identifier of the port Q are input as parameters. The blocking port judgement processing is the same as the processing illustrated in FIG. 11, and hence a description thereof is omitted here.

When the processing of Steps 2704 and 2705 has not been executed on all the flow entries in a flow table U of the communication apparatus U, the assertion generation module 211 returns the processing to Step 2703, and selects a new processing target flow entry E. When the processing of Steps 2704 and 2705 has been executed on all the flow entries in the flow table U of the communication apparatus U, the assertion generation module 211 advances the processing to Step 2707 (2706).

The assertion generation module 211 selects a processing target flow entry E from the flow entries in the flow table F, and executes the processing of Steps 2708 to 2712 (2707). The processing of Steps 2708 to 2712 is repeated until the processing has been executed on all the flow entries in the flow table F.

In the same manner as in the processing of Step 2704, the assertion generation module 211 extracts the output port Q registered in the Action of the flow entry E selected by the processing of Step 2707 (2708).

Next, the assertion generation module 211 refers to the topology table 224B of the topology DB 125, and acquires the identifier of the port P of the communication apparatus X coupled to the output port Q and the identifier of the communication apparatus X (2709).

Next, the assertion generation module 211 calls assertion entry generation processing using the assertion list A, the identifier of the port P, the identifier of the port Q, the flow entry E, and the group table G as parameters, and executes the assertion entry generation processing (2710). The assertion entry generation processing, which is processing for generating an assertion entry having a possibility of being registered in the assertion table 132 of the communication apparatus X adjacent to the communication apparatus U, is the same as the processing illustrated in FIG. 12, and hence a description thereof is omitted here. Further, the assertion entry generated by the assertion entry generation processing is stored in the final entry of the assertion list A.

Next, the assertion generation module 211 sets the assertion entry stored in the final entry of the assertion list A (assertion entry generated by the processing of Step 2710) in the communication apparatus X (2711). Specifically, the assertion generation module 211 refers to the communication apparatus management table 224A of the topology DB 125, acquires the address of the communication apparatus X, and transmits the generated assertion entry to the communication apparatus X via the management I/F 110. The communication apparatus X is configured to register the received assertion entry in the assertion memory 133.

When the processing of Steps 2708 to 2711 has not been executed on all the flow entries in the flow table F of the communication apparatus U, the assertion generation module 211 returns the processing to Step 2707, and selects a new processing target flow entry E. When the processing of Step 2708 to 2711 has been executed on all the flow entries in the flow table F of the communication apparatus U, the assertion generation module 211 advances the processing to Step 2713 (2712).

In the processing of Step 2713, the assertion generation module 211 registers all the assertion entries registered in the assertion list A in the assertion DB 221 (2713), and finishes the assertion table generation processing.

In the assertion table generation processing according to this embodiment, a given communication apparatus 100 is configured to generate an assertion entry for an adjacent communication apparatus 100 by referring to a flow table in the given communication apparatus 100. However, the given communication apparatus 100 may also be configured to generate an assertion entry for the given communication apparatus 100 by referring to the flow table of the adjacent communication apparatus 100.

FIG. 28 is a flowchart of the assertion entry priority update processing according to the second embodiment.

The assertion entry priority update processing is processing for updating the priority of an assertion entry of an adjacent communication apparatus 100. The assertion entry priority update processing is executed by the assertion control module 131.

The assertion control module 131 acquires, as the flow table F, the flow table 123 of the communication apparatus 100 (itself) having the assertion control module 131 (2801).

Next, the assertion control module 131 selects a processing target flow entry E from the flow table F acquired by the processing of Step 2801, and executes the processing of Steps 2803 and 2804 (2802). The processing of Steps 2803 and 2804 is repeated until the processing has been executed on all the flow entries in the flow table F.

The assertion control module 131 refers to the assertion DB 221, acquires the assertion entry corresponding to the flow entry E, and updates the priority of the acquired assertion entry to the priority corresponding to the number of packets registered in the Statistics of the flow entry E (2803). Specifically, the assertion control module 131 acquires the assertion entry in which the identifier of the apparatus itself and the identifier of the flow entry E are registered in the Flow Entry 601 of the assertion DB 221. Then, the assertion control module 131 decides the priority corresponding to the number of packets registered in the Statistics of the flow entry E, and register the decided priority in the Priority of the acquired assertion entry.

Next, the assertion control module 131 sets the priority of the assertion entry updated by the processing of Step 2803 in a communication apparatus 100 capable of registering that assertion entry (2804). Specifically, the assertion control module 131 acquires the identifier of the communication apparatus 100 registered in the Target Field of the assertion entry updated by the processing of Step 2803 in the assertion DB 221. Then, the assertion control module 131 refers to the communication apparatus management table 224A of the topology DB 125, acquires the address of that communication apparatus 100, and transmits the assertion entry having the updated priority to the communication apparatus 100 via the management I/F 110.

When the processing of Steps 2803 and 2804 has not been executed on all the flow entries in the flow table F of the apparatus, the assertion generation module 211 returns the processing to Step 2802, and selects a new processing target flow entry E. When the processing of Steps 2803 and 2804 has been executed on all the flow entries in the flow table F of the apparatus, the assertion generation module 211 finishes the assertion entry priority update processing.

In the assertion entry priority update processing according to this embodiment, a given communication apparatus 100 is configured to update the priority of an assertion entry of an adjacent communication apparatus 100 by referring to the flow table in the given communication apparatus 100. However, the given communication apparatus 100 may also be configured to update the priority of an assertion entry of the given communication apparatus 100 by referring to the flow table of the adjacent communication apparatus 100.

According to this embodiment, the communication apparatus 100 is configured to generate the assertion table and to update the priority of the assertion entry. As a result, the processing load on the control apparatus 200 can be reduced. In particular, the processing for periodically collecting statistical information on all the communication apparatus 100 by the control apparatus 200 involves a high processing load and a high network load. Therefore, distributing the processing load on the control apparatus 200 among the communication apparatus 100 in the manner according to this embodiment allows the processing load on the control apparatus 200 to be reduced. As a result, this embodiment can be realized even in a low-performance and inexpensive control apparatus 200. Further, through setting assertions in an autonomous and distributed manner by the communication apparatus 100, failure tolerance of the assertion settings for the overall network is better than when the control apparatus 200 sets the assertions in a concentrated manner.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit.

The above-described configurations and functions may be implemented by software, which means that a processor interprets and executes programs providing the functions.

The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected.

What is claimed is:

1. A communication apparatus for transmitting and receiving data, the communication apparatus being configured to:
store assertion information in which a failure detection condition is registered, the failure detection condition including information for identifying data that is not to be received during normal operation;
refer to the assertion information when data has been received from another communication apparatus;
judge whether or not the received data satisfies the failure detection condition registered in the assertion information; and
detect a failure when it is judged that the received data satisfies the failure detection condition registered in the assertion information.

2. The communication apparatus according to claim 1,
wherein the communication apparatus comprises ports coupled to at least one another communication apparatus, and
wherein the information for identifying data that is not to be received during normal operation, which is included in the failure detection condition registered in the assertion information, includes an identifier of, among the ports, a port coupled to a communication apparatus configured to not transfer data to the communication apparatus itself during normal operation.

3. The communication apparatus according to claim 2, wherein the communication apparatus is configured to:
store flow information in which a flow entry is registered in which a condition relating to the received data and an action to be taken on data matching the condition are associated;
store topology information in which a coupling relationship between the ports of the communication apparatus and ports of another communication apparatus is registered;
identify an output port of data matching a condition corresponding to the action when the action of the flow information satisfies a predetermined condition;
refer to the topology information and identify a port of another communication apparatus coupled to the identified output port;
generate assertion information including an identifier of the port of the another communication apparatus as the failure detection condition; and
set the generated assertion information in the another communication apparatus.

4. The communication apparatus according to claim 2, further comprising:
a retrieval memory configured to store flow information in which a flow entry is registered in which a condition relating to the received data and an action to be taken on data matching the condition are associated, and the assertion information; and
a memory configured to store assertion candidate information in which a failure detection condition having a possibility of being registered in the assertion information is registered,
wherein the retrieval memory has a smaller storage capacity than a storage capacity of the memory,
wherein a number of failure detection conditions capable of being registered in the assertion information stored in the retrieval memory is smaller than a number of failure detection conditions capable of being registered in the assertion candidate information stored in the memory,
wherein a priority is given to the failure detection condition registered in the assertion candidate information, and
wherein the failure detection condition registered in the assertion candidate information is registered in the assertion information based on the priority.

5. The communication apparatus according to claim 4, wherein the communication apparatus is configured to:
manage a failure detection condition registered in assertion candidate information of an adjacent communication apparatus;
store flow information including a flow entry in which a condition relating to the received data, an action to be taken on data matching the condition, and a number of receptions of data matching the condition are associated;
store topology information in which a coupling relationship between ports of the communication apparatus and ports of another communication apparatus is registered;
identify an output port of data matching a condition corresponding to the action when the action of the flow information satisfies a predetermined condition;
refer to the topology information and identify a port of another communication apparatus coupled to the identified output port;
generate an identifier of the port of the another communication apparatus as the failure detection condition;
set the generated failure detection condition in the another communication apparatus;
store assertion management information in which the generated failure detection condition and an identifier of the flow entry used to generate the failure detection condition are associated;
update the priority of the failure detection condition associated with the identifier of the flow entry based on a number of receptions registered in the flow entry included in the flow information; and
set the updated priority of the failure detection condition in the another communication apparatus.

6. The communication apparatus according to claim 1,
wherein a plurality of failure detection conditions for detecting different types of failure are registered in the assertion information,
wherein at least one of the plurality of failure detection conditions is a condition for detecting, in a redundant network configuration comprising an active system path through which data is communicated during normal operation and a standby system path through which data is communicated when a failure has occurred, a failure relating to a redundant network for indicating that data has been communicated through the standby system path, and
wherein the communication apparatus is configured to:
temporarily store the received data when it is judged that the received data satisfies the condition for detecting a failure relating to the redundant network;
judge, when there has been a switch from the active system path to the standby system path, that a failure relating to the redundant network does not occur, and transfer the temporarily stored data; and
detect, when there has not been a switch from the active system path to the standby system path, a failure relating to the redundant network, and discard the temporarily stored data.

7. A control apparatus configured to control a network constructed from a plurality of communication apparatuses configured to transmit and receive data, the control apparatus being configured to:
set in the plurality of communication apparatuses a failure detection condition including information for identifying data that is not to be received by the plurality of communication apparatuses during normal operation; and
manage the failure detection condition set in the plurality of communication apparatuses,
each of the plurality of communication apparatuses being configured to:
register and store in assertion information the failure detection condition set from the control apparatus;
refer to the assertion information when data has been received from another communication apparatus,
judge whether or not the received data satisfies the failure detection condition registered in the assertion information; and
detect a failure when it is judged that the received data satisfies the failure detection condition registered in the assertion information.

8. The control apparatus according to claim 7,
wherein each of the plurality of communication apparatuses comprises ports coupled to at least one another communication apparatus, and
wherein the information for identifying data that is not to be received during normal operation, which is included in the failure detection condition registered in the assertion information, includes an identifier of, among the ports, a port coupled to a communication apparatus configured to not transfer data to the each of the plurality of communication apparatuses itself during normal operation.

9. The control apparatus according to claim 8,
wherein the plurality of communication apparatuses are configured to store flow information in which a flow entry is registered in which a condition relating to the received data and an action to be taken on data matching the condition are associated, and
wherein the control apparatus is configured to:
store the flow information stored in the plurality of communication apparatuses;
store topology information in which a coupling relationship between the ports of the plurality of communication apparatuses is registered;
refer, when generating assertion information on a given communication apparatus, to the topology information, and identify a communication apparatus having a port coupled to a given port of the given communication apparatus;
acquire the flow information on the identified communication apparatus;
generate, when the action of the acquired flow information satisfies a predetermined condition, the failure detection condition including an identifier of the given port of the given communication apparatus; and
set the generated failure detection condition in the given communication apparatus.

10. The control apparatus according to claim 9,
wherein the control apparatus is configured to:
store assertion priority information in which a priority corresponding to a type of failure to be detected based on the failure detection condition is registered;
refer to the assertion priority information when the failure detection condition has been generated, and acquire the priority corresponding to the type of failure to be detected by the generated failure detection condition; and
give the acquired priority to the generated failure detection condition, and set the failure detection condition to which the priority has been given in the plurality of communication apparatuses,
wherein each of the plurality of communication apparatuses further comprises:
a retrieval memory configured to store the flow information and the assertion information; and
a memory configured to store assertion candidate information in which a failure detection condition having a possibility of being registered in the assertion information is registered,
wherein the retrieval memory has a smaller storage capacity than a storage capacity of the memory,
wherein a number of failure detection conditions capable of being registered in the assertion information stored in the retrieval memory is smaller than a number of failure detection conditions capable of being registered in the assertion candidate information stored in the memory,
wherein the failure detection condition set from the plurality of communication apparatuses is registered and stored in the assertion candidate information, and
wherein the failure detection condition registered in the assertion candidate information is registered in the assertion information based on the priority given to the failure detection condition registered in the assertion candidate information.

11. The control apparatus according to claim 10,
wherein in a flow entry in the flow information, a number of receptions of data matching the condition of the flow entry is also registered, and
wherein the control apparatus is configured to:
associate and store the generated failure detection condition and an identifier of the flow entry used to generate the failure detection condition;
update the priority of the failure detection condition associated with the identifier of the flow entry based on the number of receptions of the data registered in the flow entry included in the flow information; and
set the updated priority of the failure detection condition in the plurality of communication apparatuses.

12. The control apparatus according to claim 7,
wherein a plurality of failure detection conditions for detecting different types of failure are registered in the assertion information,
wherein at least one of the plurality of failure detection conditions is a condition for detecting, in a redundant network configuration comprising an active system path through which data is communicated during normal operation and a standby system path through which data is communicated when a failure has occurred, a failure relating to a redundant network for indicating that data has been communicated through the standby system path,
wherein the plurality of communication apparatuses are configured to temporarily store the received data when it is judged that the received data satisfies the condition for detecting a failure relating to the redundant network, and issue a query to the control apparatus regarding whether or not there has been a switch from the active system path to the standby system path,
wherein the control apparatus is configured to transmit to the plurality of communication apparatuses information indicating whether or not there has been a switch from the active system path to the standby system path in response to the query from the plurality of communication apparatuses, and
wherein the plurality of communication apparatuses are configured to:
judge that a failure relating to the redundant network does not occur and transfer the temporarily stored data when there has been a switch from the active system path to the standby system path; and
detect a failure relating to the redundant network, and discard the temporarily stored data when there has not been a switch from the active system path to the standby system path.

13. The control apparatus according to claim 8,
wherein the control apparatus is configured to store the topology information in which a coupling relationship between the ports of the plurality of communication apparatuses is registered,
wherein the plurality of communication apparatuses are configured to notify the control apparatus that the failure has been detected when the received data satisfies the failure detection condition registered in the assertion information, and
wherein the control apparatus is configured to:
refer, when the control apparatus has been notified from the plurality of communication apparatuses that a failure has been detected, to the topology information, and identify the communication apparatus coupled to the port identified by the identifier of the port included in the failure detection information in which the failure has been detected; and
identify a location of the failure by judging whether or not the failure is detected by the identified communication apparatus.

14. A communication system, comprising:
a plurality of communication apparatuses configured to transmit and receive data; and
a control apparatus configured to control a network constructed from the plurality of communication apparatuses,
each of the plurality of communication apparatuses being configured to:
store assertion information in which a failure detection condition is registered, the failure detection condition including information for identifying data that is not to be received during normal operation;
refer to the assertion information when data has been received from another communication apparatus,
judge whether or not the received data satisfies the failure detection condition registered in the assertion information; and
detect a failure when it is judged that the received data satisfies the failure detection condition registered in the assertion information,
the control apparatus being configured to:
manage the assertion information stored in the plurality of communication apparatuses; and
set the assertion information in the plurality of communication apparatuses.
